(19) United States
(12) Patent Application Publication
(10) Pub. No.: US 2003/0179916 A1
(43) Pub. Date: Sep. 25, 2003

(54) High-throughput cell identification and isolation method and apparatus

(76) Inventors: Terry R. Magnuson, Chapel Hill, NC (US); Yijing Chen, Chapel Hill, NC (US); Della Yee, Chapel Hill, NC (US); Harvey A. Zar, Chapel Hill, NC (US)

Correspondence Address: JENKINS & WILSON, PA, 3100 TOWER BLVD, SUITE 1400, DURHAM, NC, 27707, US

(21) Appl. No.: 10/359,929

(22) Filed: Feb. 6, 2003

Related U.S. Application Data
(60) Provisional application No. 60/354,803, filed on Feb. 6, 2002.

(51) Int. Cl. G06K 9/00

(52) U.S. Cl. 382/128

(57) ABSTRACT

An apparatus for identifying and isolating adherent cells expressing morphology meeting a set of predetermined criteria. Methods for employing the apparatus to identify and to identify and isolate adherent cells are also provided.

### CROSS REFERENCE TO RELATED APPLICATIONS

The present patent application is based on and claims priority to U.S. Provisional Application Serial No. 60/354,803, entitled “HIGH-THROUGHPUT CELL IDENTIFICATION AND ISOLATION METHOD AND APPARATUS”, which was filed Feb. 6, 2002 and is incorporated herein by reference in its entirety.

### TECHNICAL FIELD

The present invention relates generally to the automated identification and isolation of cells and cell colonies. More particularly, the present invention relates to the automated selection and transfer of adherent cells, such as embryonic stem cells. The present invention also relates to identifying and characterizing the morphology of cells and colonies.

Abbreviations

| | |
|---|---|
| ENU | N-ethyl-N-nitrosourea |
| ES | embryonic stem |
| GUI | graphical user interface |
| LIF | leukemia inhibitory factor |
| MACS | magnetic cell separation |
| MIL | MATROX ™ image library |
| NSD | normalized standard deviation |

### BACKGROUND ART

In general, stem cells are undifferentiated cells that can give rise to a succession of mature functional cells. For example, a hematopoietic stem cell can give rise to any of the different types of terminally differentiated blood cells. Embryonic stem (ES) cells are derived from the embryo and are pluripotent, thus possessing the capability of developing into any organ or tissue type or, at least potentially, into a complete embryo.

One of the seminal achievements of mammalian embryology of the last decade is the ability to modify the mouse genome through the use of mouse ES cells. This alteration has created a bridge between the in vitro manipulations of molecular biology and an understanding of gene function in the intact animal. Mouse ES cells are undifferentiated, pluripotent cells derived in vitro from preimplantation embryos (Evans et al., 1981; Martin 1981). Mouse ES cells maintain an undifferentiated state through serial passages when cultured in the presence of fibroblast feeder layers in the presence of Leukemia Inhibitory Factor (LIF) (Williams et al., 1988). If LIF is removed, mouse ES cells differentiate.

Mouse ES cells cultured under non-attaching conditions aggregate and differentiate into simple embryoid bodies, with an outer layer of endoderm and an inner core of primitive ectoderm. If these embryoid bodies are then allowed to attach onto a tissue culture surface, disorganized differentiation of various cell types, including nerves, blood cells, muscle, and cartilage, occurs (Martin 1981; Doetschman et al., 1985). Mouse ES cells injected into syngeneic mice form teratocarcinomas that exhibit disorganized differentiation, often with representatives of all three embryonic germ layers. Mouse ES cells combined into chimeras with normal preimplantation embryos and returned to the uterus participate in normal development (Richard et al., 1994).

Mutagenesis has long been a fundamental tool for the genetic analysis of experimentally tractable organisms such as yeast, fruit flies, and nematodes. Large-scale mutagenesis programs have played a role in the identification of genes controlling cellular and developmental pathways in these organisms and have also provided a wealth of genetic information regarding organogenesis in zebrafish. See Haffter et al., 1996; Driever et al., 1996. Despite its long history as a model system for mammalian genetics, as well as a decade of gene targeting experiments, mutations exist for only a small percentage of the genes in the mouse genome (˜3%) (Chen et al., 2000).

The discovery that exposure to ionizing radiation and certain chemicals can cause mutations in mouse germ cells led to numerous mutagenesis programs aimed at expanding the mouse mutation resource. N-ethyl-N-nitrosourea (ENU), an alkylating agent that mainly causes DNA base substitutions, has spurred several genome wide screens (Nolan et al., 1997; Kasarskis et al., 1998; Vitaterna et al., 1994) as well as region-specific mutation screens (Justice & Bode 1986; Rinchik et al., 1994; Rinchik & Carpenter 1999; Shedlovsky et al., 1988).

The high cost of animal husbandry and the difficulties monitoring and optimizing mutation frequency are significant limitations of the whole-animal mutagenesis approach. An alternative strategy would be to generate mutations in totipotent embryonic stem (ES) cells, and then derive mice from the mutagenized cells. See Chen et al., 2000. A high mutation rate coupled with high throughput mutation detection technology render this approach applicable to generating mutations in any gene(s) of interest, thereby creating an allelic series of mutations pivotal for a complete dissection of biological pathways. A cryopreserved bank of mutagenized ES cells could be generated through these approaches (Chen et al., 2000). The success of ES cell mutagenesis experiments illustrates the feasibility of using chemical mutagens to generate allelic series of mutations in a genotype-based fashion (Chen et al., 2000). Coupled with the technological advancements in mutation detection, ES cell mutagenesis becomes a powerful addition to the existing collection of tools for genetic analysis. The employment of a combination of these tools will help reshape functional genomics by delivering an expanded repertoire of mouse mutants for assessing gene function in a comprehensive and large-scale fashion.

Current protocols involve introducing mutations into ES cells with ENU. Treated cells are then washed, resuspended, and plated at low density to allow colony formation. Colonies meeting stringent morphological requirements are handpicked into 96 well plates and triplicate plated. Two plates are cryopreserved and the third is prepared for mutation detection (Chen et al., 2000).

The amount of ES cell culture demands automation to reduce labor costs and increase productivity. Based on preliminary data, 2000-4000 colonies should give 10-20 unique mutations per gene, depending on locus size (Chen et al., 2000). The time-consuming process of selecting and isolating cells has thus far been a limiting step in the process of screening for mutations in ES cells.

Bacterial and other kinds of cells have a low affinity for their growth surface. In contrast, adherent cells, such as ES cells, have a high affinity for their growth surface, which is fashioned of a rigid material such as etched or sintered glass or, more commonly, hard plastic. Thus, adherent cells cannot be isolated with prior art apparatuses employing a “stabbing” action to collect cells on a probe due to the rigid character of the growth surface. Prior art methods and apparatuses in which bacterial cells are isolated from a soft agar-based surface thus cannot be directly employed to isolate adherent cell colonies. Representative embodiments of such systems include: QPIX2™ Colony Picker (Genetix, Ltd., Queensway, New Milton, Hampshire, England); AUTOGENESYS™ Automated Colony and Plaque Picking (AutoGen, Inc., Holliston, Mass., United States of America); BIOPICK™ automated colony picking system (BioRobotics, Inc., Woburn, Mass., United States of America); Hallett & Hallett, 2000; and the Colony Picking Machine (Lawrence Berkeley National Laboratory Human Genome Center, University of California at Berkeley, Berkeley, Calif., United States of America).

Additionally, prior art cell transfer methods cannot be employed to isolate adherent cells. Some prior art methods disclose transferring and/or harvesting bacterial cells that are grown on a sheet or other semi-rigid surface. These apparatuses affect a transfer by contacting a filter or other device with the cells and subsequently contacting the filter with another material, whereby cells are transferred and harvested. Such apparatuses do not meet the need to remove colonies exhibiting a specific morphology and do not account for the fact that adherent cells are resistant to transfer via this approach.

Another problem with these methods, however, is that they have not been, or cannot be, easily automated. Indeed, even methods that disclose physical scraping motions (eq. U.S. Pat. No. 5,843,644 to Liotta et al.) are not automated and therefore still suffer from the problem that a researcher must manually operate these devices. Moreover, these methods cannot distinguish between cells based on cell morphology. Thus, known methods cannot identify and remove adherent cells or colonies (eq. undifferentiated or differentiated stem cells) without input from or interaction by an operator.

What is needed, therefore, is an automated apparatus and method for identifying adherent cell colonies that conform to a set of user-defined criteria. Following identification, the cells would then be removed from their growth plate and located on another surface, such as a 96 well plate. Such a method would be automated to eliminate the tedious and time-consuming chore of manually identifying and picking cells conforming to a set of selection criteria. In one aspect, the present invention provides such an apparatus and method.

### SUMMARY OF THE INVENTION

An apparatus for the automated isolation of a colony of adherent cells from a growth substrate based on a set of morphology-based selection criteria is disclosed. In one embodiment, the apparatus comprises: (a) an image acquisition component comprising an image recording device; (b) an image analysis component comprising a selection algorithm; and (c) a robotic manipulator component adapted to remove an adherent cell from a growth substrate, wherein the image acquisition component, the image analysis component, and the robotic manipulator component are adapted to send, receive, or both send and receive signals from each other. Optionally, the apparatus further comprises a receiving vessel. In one embodiment, the receiving vessel comprises a 96 well plate. In another embodiment, the receiving vessel comprises a 384 well plate.

A method for the automated isolation of a colony of adherent cells from a growth substrate based on a set of selection criteria is also disclosed. In one embodiment, the method comprises: (a) providing a sample comprising one or more colonies of adherent cells disposed on a growth substrate; (b) generating an image of at least a portion of the sample; (c) analyzing the image by employing a selection algorithm to identify a colony to be isolated; and (d) transferring the colony to be isolated from the growth substrate to a receiving vessel, whereby a colony of adherent cells from a growth substrate is isolated.

A method of identifying a colony of adherent cells having a desired morphology is also disclosed. In one embodiment, the method comprises: (a) providing a sample comprising one or more colonies of adherent cells in the presence of or disposed on a growth substrate; (b) generating a digitized image of at least a portion of the sample; (c) analyzing the digitized image by employing a morphology-based selection algorithm to identify a colony to be isolated, whereby a colony of adherent cells having a desired morphology is identified.

In each of the foregoing embodiments, an image-recording device includes, but is not limited to a digital still camera and a video camera. The image acquisition component can comprise an analog-to-digital converter and/or a frame grabber, although the image acquisition component is not limited to these embodiments. Furthermore, the image-generating component can comprise a scanning component adapted to acquire an image by rastering. Optionally, the image acquisition component can further comprise a magnifying device. In this embodiment, a magnifying device includes, but is not limited to a light microscope. In alternative embodiments, the light microscope is selected from the group consisting of an inverted light microscope, a darkfield microscope, a confocal microscope, and a phase microscope. Representative magnifying devices can comprise a lens, and can further comprise a collection of lenses. In one embodiment, the lens is oriented to provide magnification. Representative magnifying devices can also include, but are not limited to cameras, such as uplook cameras and downlook cameras.

In one embodiment, an image analysis component and/or step comprises a microchip embodying the selection algorithm. In another embodiment, an image analysis component and/or step comprises a computer running the selection algorithm, although other image analysis components can be employed. In one embodiment, the algorithm is a morphology-based selection algorithm. In one embodiment, the morphology-based selection algorithm is based on an evaluation of at least one property selected from the group consisting of diameter, thickness, roundness or edge regularity, degree of differentiation, regularity of surface, monoclonality, and combinations thereof.

With respect to a robotic manipulator component and/or transferring step, the transferring can optionally employ a tip having a scraping edge. Alternatively, the transferring employs a suction source and a tip adapted to aspirate a colony from the surface of a growth substrate. In yet another alternative embodiment, the transferring employs a suction source and a tip having a scraping edge and adapted to aspirate a colony from the surface of a growth substrate.

Additionally, an apparatus and method of the present invention can further comprise a growth substrate transfer device or the use thereof, the growth substrate device adapted to orient a growth substrate proximate to the image acquisition component and to subsequently remove the growth substrate from the vicinity of the image acquisition component. Alternatively, a plurality of growth substrates is sequentially oriented proximate to the image acquisition component and sequentially removed from the vicinity of the image acquisition component.

A computer program product comprising computer executable instructions embodied in a computer-readable medium for performing steps for automatically isolating a colony of adherent cells from a growth substrate based on a set of selection criteria is also disclosed. In one embodiment, the steps comprise: (a) automatically generating an image of at least a portion of a sample comprising one or more colonies of adherent cells disposed on a growth substrate; (b) automatically analyzing the image by employing a selection algorithm to identify a colony to be isolated; and (c) automatically transferring the colony to be isolated from the growth substrate to a receiving vessel, whereby a colony of adherent cells from a growth substrate is isolated.

In one embodiment, the image is a digitized image. In one embodiment, the algorithm is a morphology-based selection algorithm. In one embodiment, the morphology-based selection algorithm is based on an evaluation of at least one property selected from the group consisting of diameter, thickness, roundness or edge regularity, degree of differentiation, regularity of surface, monoclonality, and combinations thereof.

The transferring can optionally employ a tip having a scraping edge. Alternatively, the transferring employs a suction source and a tip adapted to aspirate a colony from the surface of a growth substrate. In yet another alternative embodiment, the transferring employs a suction source and a tip having a scraping edge and adapted to aspirate a colony from the surface of a growth substrate.

A computer program product comprising computer executable instructions embodied in a computer-readable medium for performing steps for automatically identifying a colony of adherent cells from a growth substrate based on a set of selection criteria is also disclosed. In one embodiment, the steps comprise: (a) automatically generating a digitized image of at least a portion of the sample; and (b) automatically analyzing the digitized image by employing a morphology-based selection algorithm to identify a colony of adherent cells having a desired morphology. In one embodiment, the morphology-based selection algorithm is based on an evaluation of at least one property selected from the group consisting of diameter, thickness, roundness or edge regularity, degree of differentiation, regularity of surface, monoclonality, and combinations thereof.

Accordingly, it is an object of the present invention to provide a method and apparatus for the automated isolation of a colony of adherent cells. This and other objects are achieved in whole or in part by the present invention.

An object of the invention having been stated hereinabove, other objects will be evident as the description proceeds, when taken in connection with the accompanying Drawings and Examples as best described hereinbelow.

### BRIEF DESCRIPTION OF THE DRAWINGS

FIG. 1 is a schematic diagram depicting the various components of an exemplary embodiment of the present invention.

FIG. 2 is a flowchart depicting an exemplary order of operations in an exemplary embodiment of the present invention.

FIG. 3 is a perspective schematic diagram depicting an exemplary design of a tip of the present invention.

FIG. 4 is a perspective schematic diagram depicting another exemplary design of a tip of the present invention.

FIGS. 5A and 5B depict highly magnified 40× digitized microscopic images in 640×480 matrices of original desirable and undesirable cell colonies, respectively.

FIGS. 6A and 6B depict smoothed versions of the original desirable (FIG. 6A) and undesirable (FIG. 6B) cell colony images shown in FIGS. 5A and 5B.

FIGS. 7A and 7B depict edge contours obtained from applying the Sobel edge enhancement operator to the smoothed version of the original desirable (FIG. 7A) and undesirable (FIG. 7B) cell colony images shown in FIGS. 6A and 6B.

FIGS. 8A and 8B depict edge contours obtained from applying the Sobel edge enhancement operator to a less smoothed version of the original desirable (FIG. 8A) and undesirable (FIG. 8B) cell colony images shown in FIGS. 6A and 6B.

FIGS. 9A and 9B depict preprocessed images obtained from applying a morphological gradient operator that subtracts an eroded version of the original desirable (FIG. 9A) and undesirable (FIG. 9B) cell colony images shown in FIGS. 5A and 5B.

FIGS. 10A and 10B depict smoothed versions of the preprocessed desirable (FIG. 10A) and undesirable (FIG. 10B) cell colony images shown in FIGS. 9A and 9B.

FIGS. 11A and 11B depict edge contours obtained by applying the Sobel operator to a smooth version of the preprocessed original desirable (FIG. 11A) and undesirable (FIG. 11B) cell colony images shown in FIGS. 9A and 9B (less smooth than the ones shown in FIGS. 10A and 10B).

FIGS. 12A and 12B depict edge contours obtained by applying the Sobel operator to a smooth version of the desirable (FIG. 12A) and undesirable (FIG. 12B) cell colony images shown in FIGS. 10A and 10B.

FIGS. 13A and 13B depict darkfield images of a small colony of good morphology (FIG. 13A) and a processed image of the colony shown in FIG. 13A with the core extracted (FIG. 13B).

FIG. 14 depicts the final image of the colony shown in FIG. 13A after processing.

FIG. 15 illustrates an exemplary general purpose computing platform 100 upon which the methods and systems of the present invention can be implemented.

### DETAILED DESCRIPTION OF THE INVENTION

I. Definitions

Following long-standing patent law convention, the terms “a” and “an” refer to “one or more” when used in this application, including the claims.

The term “about”, as used herein when referring to a measurable value such as a size, a length, etc., refer to variations of in one embodiment ±20%, in another embodiment ±10%, in another embodiment ±5%, in another embodiment ±1%, and in still another embodiment ±0.1% from the specified amount, as such variations are appropriate to perform the disclosed method.

As used herein, the term “automated”, “automatedly”, “automatically”, and grammatical derivatives thereof, refer to an action performed without human intervention. Human intervention can precede or follow an automated action; however, while the action is occurring, no human intervention is required or needed.

As used herein, the term “edge detection” refers to an operation by which the edges of an object, represented in digital form, are traced in order to arrive at an outline of the object. Edge detection typically is achieved by employing an algorithm developed to identify features that typically denote edges; these parameters will be dependent on the general type of sample under analysis (biological samples, samples of different materials, etc.). When the sample is a biological sample, edge detection can rely, for example, on properties associated with cell membranes.

As used herein, the term “growth substrate” refers to any surface upon which biological material can live. For example, when adherent cells are under study, a growth surface includes, but is not limited to a hard plastic sheet or dish.

As used herein, the term “image analysis component” refers to a collection of one or more elements that can collectively function to evaluate an image (for example, a digitized image) according to a set of predefined criteria. In the present invention, an image analysis component performs an evaluation of an image to identify individual colonies and to further identify which of the identified colonies meets requisite morphological characteristics.

As used herein, the term “image acquisition component” refers to a collection of one or more elements that can collectively function to acquire an image of a sample: in one embodiment, a digitized image. In the present invention, an image acquisition component can comprise, for example, a camera adapted to acquire an image of a sample. Both video and still cameras can be employed. If the camera acquires an analog image, an image acquisition component can optionally convert the image to digital form, which can then be analyzed by an image analysis component. The image acquisition component can also include a filter, for example, an emission filter if the cells are to be viewed under fluorescence. In one embodiment, an image acquisition component comprising an emission filter can be used to detect cell colonies that express a fluorescent marker. In this embodiment, the image acquisition component can be used to detect only colonies that express (or fail to express) the fluorescent marker under user-defined parameters. For example, ES cells can be transfected with a fluorescent marker gene that is expressed only when the ES cells are in an undifferentiated state. Alternatively, the ES cells can be transfected with a fluorescent marker that is induced as ES cells lose their totipotent or pluripotent phenotype.

As used herein, the term “magnifying device” refers to any device adapted to visualize features of a sample not normally discernable with the naked eye or to enhance features of a sample that are at least partially visible to the naked eye. For example, in one embodiment a magnifying device is a light microscope, which facilitates the observation of certain features of a sample, such as adherent cell colonies, not normally observable without assistance.

As used herein, the term “morphology-based selection algorithm” refers to a set of instructions facilitating the selection of an object based on the morphology of the object. Generally, a morphology-based selection algorithm comprises a series of steps that comprise comparing one or more morphological features of an image to a set of predetermined morphology criteria to determine if the features of the image meet the criteria. Representative morphology criteria include, but are not limited to diameter, thickness, roundness or edge regularity, degree of differentiation, regularity of surface, monoclonality, and combinations thereof.

As used herein, the term “mastering” refers to a pattern of parallel lines. When the term is employed in the description of a scanning pattern, the term means a pattern of successive scans, each scan being parallel to the scan previous, yet covering a different area.

As used herein, the term “receiving vessel” refers to any vessel adapted to receive a biological sample. In one embodiment, a receiving vessel is a 96 well plate, and in another embodiment, a receiving vessel is a 384 well plate; however, any substrate can be employed, including, but not limited to a dish, a multiwell plate, and a sheet. In alternative embodiments, receiving vessels, including, but not limited to dishes, multiwell plates, and sheets, are manufactured of durable plastic or other material to which adherent cells can efficiently adhere.

As used herein, the term “robotic manipulator component” refers to a collection of one or more elements that can collectively function to isolate a colony or cell from a growth substrate by removing it from the substrate to a receiving vessel. In the present invention, a robotic manipulator component can comprise, for example, a robot arm adapted to move to the location of a colony or cell to be isolated from a growth substrate, to remove the colony or cell from the growth substrate, and to place the colony or cell in a receiving vessel, such as a 96 well plate, a 384 well plate, or any other acceptable receiving vessel, as well a suction source operatively connected to the robot arm.

As used herein, the term “scraping edge” refers to a surface formed and adapted to contact an adherent cell or adherent cell colony and to scrape it from the surface of a growth substrate. In one embodiment, a scraping edge is disposed on, or is an integrated part of, a tip that is associated with a robot arm.

II. General Considerations

Cells cultured in vitro are valuable reagents for studying biological processes fundamental to the understanding of physiological and pathological conditions as well as for discovering therapeutic targets. One approach is to screen for desired traits in a large number of genetically or biologically modified derivatives (subclones) from established cell lines/strains. For example, embryonic stem (ES) cells can be chemically or physically mutagenized to generate a bank of cells with a wide variety of genetic modifications. The individual mutagenized ES cell clones can then be screened for particular genetic alterations. The ability to isolate a large number of modified subclones and culture them in a high throughput fashion is crucial for performing the large-scale screens that play a role in functional genomic and pharmaceutical research.

In a typical manual isolation of adherent cells and adherent cell colonies, the procedure is performed generally as follows. Although sometimes difficult to study with a standard light microscope, adherent cells can generally be viewed through an inverted microscope. Undifferentiated cells appear as small colonies. Differentiating cells appear in the field as larger cells within the colony and typically have clear and well-defined membranes. A 96 well plate, a 384 well plate, or other multiwell plate, which will receive isolated colonies and cells, can be prepared by placing a volume of media in each well. The cells and colonies, which are disposed on a growth substrate, are oriented under the microscope and viewed at various magnifications during the isolation procedure. A researcher then visually inspects the colonies and identifies cells and colonies expressing a desirable morphology. When a subject expressing a desired morphology is identified, the subject is moved away from other cells and colonies. A pipettor can be employed for this purpose. A pipettor is then employed to dislodge the subject from the plate via aspiration. The subject is then placed in a well of a 96 well plate, a 384 well plate, or another multiwell plate, which contains a suitable medium. In one embodiment, the growth plate is not exposed to ambient temperatures and/or environments for long periods of time, thereby minimizing the effect of changes in pH, temperature, and medium concentration on the cells. This process is repeated until all suitable cells and colonies have been isolated and placed in a receiving vessel.

There is presently no viable automated alternative to isolating adherent cells by handpicking the cells. That is, each cell that is to be isolated must be isolated by hand; a researcher must perform the mundane process of manually identifying a suitable cell, removing the cell from a colony, and placing the cell in the well of a receiving vessel. This is a painstakingly tedious and time-consuming process, requiring the resources of one or more individuals. Moreover, it can take many months for an individual to perfect his or her ability to accurately and quickly isolate cells having a suitable morphology.

For some applications, such as screening embryonic stem cells for induced mutations in a gene with a coding region of about 2 kilobases, 2000-4000 colonies can provide 10-20 mutations for study. Thus, it would be advantageous to provide a fully automated apparatus and method for screening colonies of adherent cells for cells that meet a given set of selection criteria. Such an apparatus and method can be adapted to receive a substrate comprising one or more colonies of cells, to image the cells, to identify colonies and cells based on a set of user-defined criteria, and to physically remove suitable cells and colonies from the substrate to a receiving vessel. In one embodiment, these operations are performed with a minimum of human interaction with the apparatus. Thus, in one embodiment, for a machine to pick colonies, regardless of colony type, four functions are performed: 1) the culture plate is imaged; 2) suitable colonies are selected; 3) colony locations are specified; and 4) a mechanical system removes the colony.

A prototypical example of an automated colony picker for bacteria is the Colony Picking Machine designed at Lawrence Berkeley National Laboratory. This colony picking apparatus includes two physically separate modules: an imaging station, and a picking station. Culture plates are manually loaded onto the imaging station where a PULNIX™ TM745E CCD camera (Pulnix America, Inc., Sunnyvale, Calif., United States of America) equipped with a NIKON® NIKKOR® 28 mm f/2.8 lens (Nikon, Inc., Melville, N.Y., United States of America) captures a digital image of the plate. The image is fed through a frame grabber to a computer where imaging software, written in OPTIMAS™ language (Media Cybernetics, Silver Spring, Md., United States of America), a high-level WINDOWS® operating system-based imaging language, analyzes the image.

Background correction is performed for lighting and agar non-uniformities and a global threshold is automatically set just below the background peak in the gray scale histogram. Objects darker than the threshold are identified as potential colonies. A series of tests selects single, round colonies and rejects those colonies that are not monoclonal (that is, colonies that originate from more than one bacteria and grow together into a fused mass). The area, aspect ratio (the ratio of length to width of a bounding rectangle parallel to the major axis of the object), and circularity (defined as the ratio of perimeter squared to area) all must meet prescribed criteria. The density profile along the major axis of each object is computed. Colonies that are not monoclonal will have more than one peak in the density profile and are rejected. The centroid coordinates of the selected colonies are then written to a file and passed to the picking module.

The culture plate is manually transferred from the imaging station to the colony picking machine. Two identical XY tables hold the source culture plate and the destination microtiter plate. The culture plates, guided by the colony coordinates, are positioned underneath a carousel of 12 picking/placing needles. A needle is plunged into the colony and cells adherent to the needle are placed in microtiter plate wells filled with bacterial growth medium. The picking needle is washed and sterilized, and the picking cycle is thus completed. The XY table then moves the plate to the coordinates of the next colony to be picked and the next needle on the carousel initiates the subsequent picking cycle.

An image analysis algorithm of the present invention also performs edge detection, size measurement, and circularity evaluation. Mammalian cell colonies to be picked, like their bacterial counterparts, must be monoclonal. Centroid coordinates are also calculated. However, mammalian cells, especially ES cells, form colonies with a much more complex and heterogeneous morphology than do bacteria. Such heterogeneity demands additional sophistications in image analysis capability to ensure that the quality of the picked colonies is sufficient to ensure the success of the experiment. The present invention meets the challenge of this significantly more demanding task.

Currently marketed robotic pickers are designed exclusively for picking bacterial (non-adherent) colonies or phage plaques formed on a soft agar-based surface. Representative pickers include: QPIX2™ Colony Picker (Genetix, Ltd., Queensway, New Milton, Hampshire, United Kingdom); AUTOGENESYS™ Automated Colony and Plaque Picking (AutoGen, Inc., Holliston, Mass., United States of America); BIOPICK™ automated colony picking system (BioRobotics, Inc., Woburn, Mass., United States of America); Hallett & Hallett 2000; and the Colony Picking Machine (Lawrence Berkeley National Laboratory Human Genome Center, University of California at Berkeley, Berkeley, Calif., United States of America).

Compared to adherent mammalian cells, bacterial colonies have far less affinity for their growth surface, the soft agar, making it possible to pick a small portion of the colonies by a simple contact. In the case of phage plaques formed on the soft agar surface, a straight forward stabbing motion is sufficient to remove the plaque along with the underlying agar support. Unlike bacteria or phages, adherent cells form colonies directly on, and adhere tightly to, a hard plastic surface. As a result, a simple stabbing motion is incapable of lifting or detaching the colonies from their growth surface. The present invention performs more complex motions, such as side-to-side scraping and simultaneous aspiration, actions that facilitate the loosening and recovery of the adherent colonies.

The present invention thus provides the first method and first robotic picking apparatus designed specifically for adherent colonies. In one embodiment, the imaging algorithm allows stem cell colonies to be automatically recognized and a specialized pipette tip (in one embodiment, a micropipette tip) adapted for robotic automation is tailored to loosen and aspirate adherent cells. The pipette tip is broadly applicable to other adherent cell types and provides high-throughput picking to a vast range of applications. Thus, a method and apparatus of the present invention can be employed to pick individual ES cell colonies as well as any other adherent cell colony.

In view of the biological importance of adherent cells in general and stem cells in particular, there exists a need for methods to accurately identify stem cells at various stages in their differentiation cycles and to isolate suitable cells. The present invention encompasses a method and apparatus adapted to identify adherent cells, including stem cells, which have developed to a degree at which is it desirable to isolate the cells. Additionally, the present invention encompasses a method and apparatus adapted to physically isolate or “pick” cells from a culture that have developed (or not developed) to a degree at which is it desirable to isolate the cells. The present invention accomplishes these and other goals to allow the identification and isolation operations to be performed unattended. For example, once a picking project is set up, minimal human intervention is required, making around-the-clock operation possible.

III. Components of a Colony Identification and Isolation Apparatus

An apparatus adapted to identify and isolate an adherent cell or colony of adherent cells can comprise a combination of components. Although the present discussion presents the invention in terms of individual components, it is stressed that this format is purely for ease of presentation. In practice, the various elements of the present invention can be integrated as a whole, or several elements can be integrated to for a multifunctional component. For example, image acquisition and processing can be achieved by employing a single component. It is additionally noted that where the following discussion refers to an adherent colony or adherent cell, it is intended that these terms are interchangeable, with the discussion being equally applicable to both cells and colonies.

In one embodiment, an apparatus of the present invention can comprise an image acquisition component, an image analysis component, a robotic manipulator component, and a receiving vessel. Each of these component elements is discussed individually herein below.

III.A. Imaging Acquisition Component

In one aspect, an image acquisition component of the present invention comprises an image recording device, such as a camera, and can also comprise a frame grabber. A video monitor adapted to display output from the camera can optionally form an element of an image acquisition component. Additionally, a source of illumination and a magnifying device can form elements of an image acquisition component. A goal of an image acquisition component is to provide a digital image that can be analyzed to identify one or more colonies conforming to a set of selection criteria.

When a source of illumination is employed, the illumination can be directly from a light source. Optionally, the illumination can be filtered before falling on a surface. For example, the light can be passed through an aperture to focus the light to a thin narrow beam. Alternatively, the focusing can be achieved by passing impingent light through a slit or a series of lenses or mirrors, which can collimate the light. In one embodiment, a source of illumination provides a degree of illumination sufficient to illuminate a fraction, or the entirety, of an area that will be occupied by the colonies of cells to be examined. In one embodiment, the light source is adapted to afford repositioning of the light source as desired. Exemplary light sources include, but are not limited to tungsten lamps, strobe lights, lasers, and incandescent lamps.

The light reflected from the growth substrate, whether the culture is directly illuminated or is simply illuminated by ambient light, is in one embodiment directed through the optical system of a magnifying device. For example, a microscope can be employed as a magnifying device. Any microscope adapted to provide magnification of a field of view can be employed. In one embodiment, a microscope is a light microscope. Representative light microscopes include, but are not limited to inverted light microscopes, dark field microscopes, confocal microscopes, and phase microscopes. Representative magnifying devices can comprise a lens, and can further comprise a collection of lenses, which can be oriented to provide magnification. Representative magnifying devices can also include cameras, such as uplook cameras and downlook cameras.

Alternatively, the cells present in the analyzed samples can be scanned and the data acquired during the scan assimilated to form a single image. Scanning can be performed by a manual, semiautomatic, or automatic scanning device capable of ordered and repeatable scanning movement (for example, rastering). Line scanning is thus an optional, and not a required, approach. Light microscopes are generally equipped with a movable stage and this aspect of a light microscope can be adapted to automatic operation.

Virtually any image recording device can be employed in the present invention. Image recording devices include, but are not limited to video cameras and still cameras, which can be digital. Black-and-white or color cameras can be employed. Alternatively, an image recording device can comprise an apparatus adapted to scan over a given area and record during the scan.

In one embodiment, if a camera is selected as an image recording device, the camera is mounted or positioned such that it can be focused on a growth substrate or, alternatively, on a region of a growth substrate, which in one embodiment is illuminated by a light source. Light reflected from the illuminated area is directed at the lens of the magnifying device and subsequently through an image recording device to provide an output representative of the area. If a digital camera is employed, the output will be in a digital form; if a non-digital camera is employed, the output will be in analog form, which can be converted to digital form if desired. If a video camera is employed, a frame grabber can be employed to isolate one frame and to digitize that frame, if needed.

The process of digitizing the image can be achieved by employing a frame grabber. The term “frame grabber” refers to a collection of equipment that, in concert, receives the analog image, converts the image to digital form, and performs other analyses, as desired. A suitable frame grabber can comprise an imaging board, such as an imaging board commercially available under the trademark MATROX™ (Matrox Graphics Inc., Dorval, Quebec, Canada). A frame grabber can also comprise a digitizer and a frame buffer, both of which can be disposed on the imaging board. The digitized signal is then fed to image analysis hardware and software, which is discussed further herein below in the Examples.

Thus, the various elements of an image acquisition component can comprise a source of illumination, a magnifying device, and a camera or other device for recording the light reflected from the illuminated and magnified area. In one embodiment, the camera is a digital camera and the magnifying device is a microscope capable of providing up to and including 40× magnification or greater. In one embodiment, the camera is a color camera with a resolution of 640 (h)×480 (v) pixels, or greater.

The output of an image acquisition component can be fed, on a separate line, to a video monitor, which is adapted to display the digitized image. The output of an image acquisition component can also be sent to a printer, which can print out a hard copy of an image. Such a video monitor or a printer can also be adapted to receive and display output from an image analysis component of the present invention. These various outputs are in addition to an output to an image analysis component.

An image acquisition component of the present invention can comprise a plurality of components. An image acquisition component can comprise both hardware and software elements. The various elements of an image acquisition component can interface with one another. For example, a software element can run on a hardware element, two or more hardware elements can operate cooperatively, or a first software element can feed a second software element. However, all of the elements remain elements of an image acquisition component. In one embodiment, an image acquisition component interfaces with at least an image analysis component. Representative components are set forth in the Examples presented herein below.

III.B. Image Analysis Component

A role of an image analysis component of the present invention is to receive an image (in one embodiment, a digitized image) from an image acquisition component and to analyze the image to identify individual cells and colonies as well as those colonies exhibiting suitable cell morphology that can be related to the cells' state of differentiation. Thus, an image analysis component communicates with an image acquisition component.

An image analysis component of the present invention can comprise a plurality of components. An image analysis component can comprise both hardware and software elements. The various elements of an image analysis component can interface with one another. For example, a software element can run on a hardware element, two or more hardware elements can operate cooperatively, or a first software element can feed a second software element. However, all of the elements remain elements of an image analysis component. In one embodiment, an image analysis component interfaces with at least an image acquisition component and a robotic manipulator component.

III.B.1. Hardware

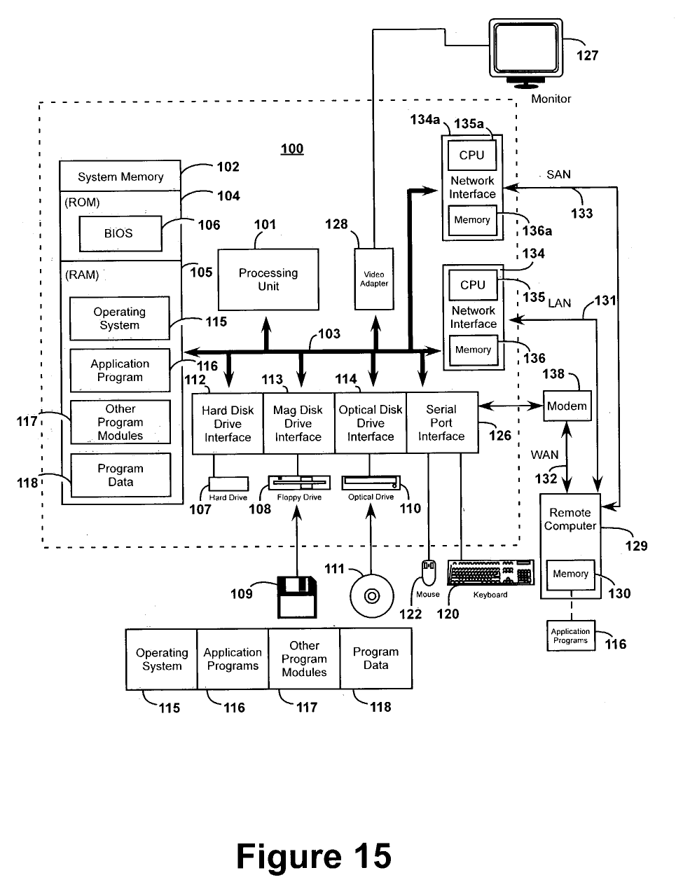

Image analysis is performed, in part, by employing an image analysis algorithm. Such an algorithm can be embodied in a software program, can be embodied on a dedicated microchip, or can be running on a computer. With reference to FIG. 15, an exemplary system for implementing these aspects of the invention includes a general purpose computing device in the form of a conventional personal computer 100, including a processing unit 101, a system memory 102, and a system bus 103 that couples various system components including the system memory to the processing unit 101. System bus 103 can be any of several types of bus structures including a memory bus or memory controller, a peripheral bus, and a local bus using any of a variety of bus architectures. The system memory includes read only memory (ROM) 104 and random access memory (RAM) 105. A basic input/output system (BIOS) 106, containing the basic routines that help to transfer information between elements within personal computer 100, such as during start-up, is stored in ROM 104. Personal computer 100 further includes a hard disk drive 107 for reading from and writing to a hard disk (not shown), a magnetic disk drive 108 for reading from or writing to a removable magnetic disk 109, and an optical disk drive 110 for reading from or writing to a removable optical disk 111 such as a CD-ROM or other optical media.

Hard disk drive 107, magnetic disk drive 108, and optical disk drive 110 are connected to system bus 103 by a hard disk drive interface 112, a magnetic disk drive interface 113, and an optical disk drive interface 114, respectively. The drives and their associated computer-readable media provide nonvolatile storage of computer readable instructions, data structures, program modules, and other data for personal computer 100. Although the exemplary environment described herein employs a hard disk, a removable magnetic disk 109, and a removable optical disk 111, it will be appreciated by those skilled in the art that other types of computer readable media which can store data that is accessible by a computer, including, but not limited to magnetic cassettes, flash memory cards, digital video disks, Bernoulli cartridges, random access memories, read only memories, and the like may also be used in the exemplary operating environment.

A number of program modules can be stored on the hard disk, magnetic disk 109, optical disk 111, ROM 104, or RAM 105, including an operating system 115, one or more applications programs 116, other program modules 117, and program data 118.

A user can enter commands and information into personal computer 100 through input devices such as a keyboard 120 and a pointing device 122. Other input devices (not shown) can include a microphone, touch panel, joystick, game pad, satellite dish, scanner, or the like. These and other input devices are often connected to processing unit 101 through a serial port interface 126 that is coupled to the system bus, but can be connected by other interfaces, such as a parallel port, game port or a universal serial bus (USB). A monitor 127 or other type of display device is also connected to system bus 103 via an interface, such as a video adapter 128. In addition to the monitor, personal computers typically include other peripheral output devices, not shown, such as speakers and printers. With regard to the present invention, the user can use one of the input devices to input data indicating the user's preference between alternatives presented to the user via monitor 127.

Personal computer 100 can operate in a networked environment using logical connections to one or more remote computers, such as a remote computer 129. Remote computer 129 can be another personal computer, a server, a router, a network PC, a peer device or other common network node, and typically includes many or all of the elements described above relative to personal computer 100, although only a memory storage device 130 has been illustrated in FIG. 15. The logical connections depicted in FIG. 15 include a local area network (LAN) 131, a wide area network (WAN) 132, and a system area network (SAN) 133. Local- and wide-area networking environments are commonplace in offices, enterprise-wide computer networks, intranets and the Internet.

System area networking environments are used to interconnect nodes within a distributed computing system, such as a cluster. For example, in the illustrated embodiment, personal computer 100 can comprise a first node in a cluster and remote computer 129 can comprise a second node in the cluster. In such an environment, it is preferable that personal computer 100 and remote computer 129 be under a common administrative domain. Thus, although computer 129 is labeled “remote”, computer 129 can be in close physical proximity to personal computer 100.

When used in a LAN or SAN networking environment, personal computer 100 is connected to local network 131 or system network 133 through network interface adapters 134 and 134a. Network interface adapters 134 and 134a can include processing units 135 and 135a and one or more memory units 136 and 136a.

When used in a WAN networking environment, personal computer 100 typically includes a modem 138 or other device for establishing communications over WAN 132. Modem 138, which can be internal or external, is connected to system bus 103 via serial port interface 126. In a networked environment, program modules depicted relative to personal computer 100, or portions thereof, can be stored in the remote memory storage device. It will be appreciated that the network connections shown are exemplary and other approaches to establishing a communications link between the computers may be used.

Thus, the hardware of an image analysis component can comprise a microchip running an algorithm. Additional hardware elements can also be employed and can comprise, for example, an additional microchip or storage medium adapted to route or manage data. A display device (for example, monitor 127; see FIG. 15) can also be employed to display the output from an applied algorithm. Generally, the hardware elements of an image analysis component comprise at least an algorithm adapted to identify individual cells and colonies and to further identify cells and colonies expressing a morphology making them suitable for isolation.

Additional hardware associated with an image analysis component of the present invention can comprise an image analysis workstation. An image analysis workstation can facilitate an optional manual evaluation of an image or can be employed to modify and/or refine an algorithm in consideration of observed or stored image analysis data. Several image analysis workstations, which can be used in conjunction with a light microscope (i.e. a magnifying device), are commercially available and include the I-CUBE™ Video Microscopy Workstation (available from I-Cube, Inc., Crofton, Md., United States of America), and the MICRO21® workstation (available from Intelligent Medical Imaging, Inc., Palm Beach Gardens, Fla., United States of America). Additional representative imaging analysis hardware components are also set forth in the Examples presented herein below. In one embodiment, an image analysis workstation is connected via a network connection (for example, a SAN, LAN, or WAN connection as seen in FIG. 15) to a computer (for example, personal computer 100; see FIG. 15).

III.B.2. Software

An image analysis component of the present invention comprises software, and this term specifically encompasses algorithms. Generally, the software is adapted to analyze a digital image acquired and/or processed by the image acquisition component. The analysis can be characterized by at least two broad goals. These goals include analyzing the image to identify individual cells and colonies of cells. This identification can comprise employing an edge detection algorithm to identify colonies and individual cells. Another goal of the analysis is to identify colonies that meet a set of predetermined morphology-based selection criteria. In one embodiment, software elements are employed to fill these roles.

Some image analysis software is commercially available and can be used as a platform for modification and deployment in the present invention. For example, commercially available software includes, but is not limited to the MATROX™ image library (MIL; available from Matrox Graphics Inc., Dorval, Quebec, Canada) and the APHELION™ product package (available from Amerinex Applied Imaging, Amherst, Mass., United States of America). Both the MIL and the APHELION™ product package utilize algorithms for edge detection or edge enhancement (see e.g., U.S. Pat. No. 5,311,600, which is incorporated herein by reference), segmentation, and blob analysis in order to analyze cell images. Additional algorithms that can be modified and incorporated into an image analysis component of the present invention are described in, for example, U.S. Pat. No. 4,878,114, which discloses a method and apparatus for assessing surface roughness; U.S. Pat. No. 4,969,198, which discloses a system for automatic inspection of periodic patterns; U.S. Pat. No. 5,830,141, which discloses image processing for automatic detection of regions of predetermined cell types; and U.S. Pat. No. 5,099,521, which discloses a cell image processing system, all of which are incorporated herein by reference. Additional representative imaging analysis software components are also set forth in the Examples presented herein below. In one embodiment, Application Programs 116 (see FIG. 15) comprise the image analysis software.

III.B.2.i. Identification of Individual Cells and Colonies

In one embodiment, identification of individual cells and colonies disposed on a growth substrate is achieved by employing an algorithm-based edge detection process. Edge detection and enhancement simplifies the subsequent analysis of images by drastically reducing the amount of data to be processed while still preserving useful information about the image. Several approaches have been developed for edge detection and can be employed in the present invention. Among them are the Gaussian filters, which form the basis for a series of algorithms for detecting sharp edges. Other methods for the detection of straight edges are based on producing a set of likely edge points by first applying some edge detection schemes, and then combining the resulting data to estimate the line coordinates of an edge; this can be done either by least squares fitting or by the Hough transform. There is also a projection-based detection method for straight line edges that analyzes the peaks in projection space to estimate the parameters of a line representing an edge. Other edge detection approaches are disclosed in the Examples, and include the Sobel/edge enhancement operator.

III.B.2.ii. Selection Based on Morphology

In another aspect of an image analysis component of the present invention, an algorithm can be employed to identify colonies and/or cells that meet a set of morphology criteria and are therefore suitable for isolation and transfer from a growth substrate to a receiving vessel.

In one embodiment of the present invention, one or more algorithms are employed to analyze a digital image acquired by an image acquisition component. The algorithms are applied to the digital image to identify certain features of the cells represented by the image. A representative, but non-limiting, list of criteria that can be identified in an image comprises diameter, thickness, roundness or edge regularity, degree of differentiation, regularity of surface, and monoclonality.

In one embodiment, a darkfield imaging system is employed for imaging the colonies. Darkfield images do not suffer from intensity inhomogeneities. Intensity inhomogeneities are low frequency intensity changes that occur across the phase contrast images. Since the algorithms do not have to account for intensity variations, thresholds valid in one section of an image are valid throughout the image. Also, the physics of the acquisition process allows one to interpret image intensity as an indication of colony thickness.

In one embodiment, an image rating scheme is employed. Instead of attempting to model the picker's entire rating scheme, only their rejection criteria are modeled. After careful consultation with the expert cell pickers, 5 classifiers have been identified that are used to reject colonies. A statistical approach is employed to train and validate our algorithms. ROC analysis (Metz 1986) is also used to measure the algorithm's sensitivity and specificity

As noted, morphological features can be identified by employing one or more algorithms. The algorithms can be adapted to operate generally as disclosed in the Examples presented below. Algorithms for use with the present invention can be stored and run on personal computer 100 (see FIG. 15).

III.B.2.iii. Image Enhancement Devices

In another aspect of the present invention, it is possible to enhance the ability of the various hardware and software elements to effectively identify colonies or cells. Thus, in one embodiment of the present invention, a mechanism or optical properties manipulator is employed, which facilitates manipulation of the optical properties of the magnified image generated by a magnifying device. Such a mechanism can be coupled to a magnifying device and/or an image analysis component. Alternatively, such a mechanism can form a part of a magnifying device and/or an image analysis component.

Optical manipulation can serve to enhance the image of the colonies or cells, such that cellular morphological features, including, for example, shape, size, outer cell edge, cellular components, and the like, are enhanced and are therefore more readily identifiable and detectable by the image analysis component. Examples of optical manipulation apparatuses known in the art include Nomarski lenses or software and phase contrast. Nomarski is a form of microscopy particularly suited for the evaluation of surface quality and defects. The Nomarski illumination method incorporates polarization and phase shift techniques, which cause minute departures of the surface from a perfect plane to appear as different colors. Phase contrast is an optical method devised by F. Zernike for converting the focused image of a phase object (one with differences in refractive index or optical path but not in absorbance), which ordinarily is not visible in focus, into an image with good contrast. Dark field microscopy is a method that creates contrast between the object and the surrounding field. As the name implies, the background is dark and the object is bright. An annular stop outside the field of view is used for dark field. Only light coming from the outside of the beam passes through the object and it cannot be seen directly. Only when light from the stop is deflected and deviated by the object can it be seen. This method produces a great deal of glare and therefore the specimen often appears as a bright silhouette rather than as a bright object. These methods are useful for optical manipulation of cells since cells are typically semitransparent to transparent to light in the visible spectrum. Optionally, to further enhance the morphological features of the analyzed cells and to render such cells more detectable by an image acquisition component, fluorescence-assisted detection can be employed. For example, the natural fluorophores and/or chromophores of a colony or cell can be employed to enhance detection and processing. In this embodiment, appropriate selection of filters can help differentiate the colony from the background. Alternatively, the media can also be modified to enhance contrast. Additionally, the growth substrate can comprise a background or color, for example, black, that enhances contrast. Thus, color additives in a variety of aspects can enhance image processing in accordance with the present invention.

III.B.3. Data Interface

A data interface also comprises an element of an image analysis component of the present invention. By employing a data interface, large numbers of colonies can be analyzed and stored. Information on initial size, morphological criteria, and sample tracking can be databased in a form compatible with other parts of the image analysis and image acquisition components.

In one embodiment, a data interface comprises a mechanism adapted to store information related to the colonies and/or cells that are selected for isolation by the algorithms of the image analysis component. A data interface can comprise, in part, a hard drive (for example, Hard Drive 107; see FIG. 15), a floppy drive (for example, Floppy Drive 108; see FIG. 15), or an optical drive (for example, Optical Drive 110; see FIG. 15) and software adapted to provide access to the information stored on a hard drive. For example, a personal computer (for example, personal computer 100; see FIG. 15) can form the basis of a data interface. A data interface can also comprise an output device, such as a computer monitor (for example, Monitor 127; FIG. 15), a printer, or a plotter.

In one embodiment, a data interface provides a search capability. It can be desirable to enable a researcher to search the records of stored data on selected (and unselected) colonies and cells. Additionally, stored data can be employed as an aid in a continual and ongoing refinement of an identification algorithm. That is, stored data can be employed in a heuristic identification algorithm, wherein the accuracy of the algorithm is continually refined and developed with each successive identification.

III.B.4.Characterization of Colony Position

Upon identification of a colony or cell having morphology meeting certain specified selection criteria, the location of the colony or cell on the cell growth substrate (for example, a hard plastic dish or sheet) is recorded. The location can be conveniently expressed in Cartesian coordinates, relative to a fixed frame of reference. Although Cartesian coordinates are an exemplary mechanism of recording colony position, other mechanisms can also be employed and can be dictated by the configuration of a robot manipulator. The position of the colony or cell can then be transmitted to a robotic manipulator component, which can remove the cell or colony.

III.C. Robotic Manipulator Component

The present invention comprises a robotic manipulator component. The robotic manipulator component operates to physically isolate a colony or cell from the other colonies or cells on the growth substrate. In operation, the robotic manipulator component receives coordinate data from an image analysis component describing the location of a colony or cell to be isolated. The robotic manipulator component moves to the location of the colony or cell and removes (i.e., “picks”) the subject from the growth substrate. The manipulator then transfers the subject to a receiving vessel and returns to position, ready to receive new coordinates from the image analysis component.

III.C.1.Manipulator Design

In one embodiment, a robotic manipulator component of the present invention comprises a robot arm and a tip element. The robot manipulator and its elements can take many forms. The design and/or selection of a robot manipulator can be dependent on the overall design of a cell picker system. This will depend, in part, on the mechanism by which a growth substrate is presented to the robot manipulator. For example, a cell picker can be arranged in sequential stations, wherein the growth substrate is conveyed from component to component, each of which is fixed in position (for example, from an image acquisition component to a colony isolation component). Alternatively, the growth substrate can be fixed in a position and the various components can be automatically oriented in positions amenable to the role each component is to play.

When a growth substrate is conveyed from location to location, a robotic manipulator can be fixed in one position relative to the other components of the system. However the manipulator retains a degree of freedom of movement sufficient to permit the manipulator to reach all areas of a growth substrate presented to it.

Commercially available robotic manipulators can be conveniently employed in the present invention. For example, the R15™ robot (available from ST Robotics, Trenton, N.J., United States of America) can be employed in the present invention. This robot, as well as other Cartesian robots, can be fitted with a suitable tip (as discussed herein below) and adapted to isolate adherent cells from a growth substrate. Such a robot can be programmed in any robotic convenient programming language, (for example, ROBOFORTH II, and other programming languages based on the FORTH, LISP or LOGO) and can be adapted to interface with a control computer's operating system. Optionally, a graphical user interface is programmed in a suitable programming language, such as VISUAL BASIC. The manufacturer's provided software package can also be used as a starting point. It is desirable to provide straightforward comments, such as “orient” or “orient plate”. Multi-welled plates are typically rectangular and thus, their coordinates can be readily accepted/programmed based on, for example, two corners of the plate. Other representative robotic systems are disclosed in the Examples presented below.

Another aspect of a robotic manipulator of the present invention is a tip adapted to remove an adherent colony or cell from a growth substrate. The tip is adapted to perform the removal by physical or assisted physical techniques. Such a tip can be disposed on a structure integrated into a robotic manipulator. In this embodiment, the robot arm itself does not contact a colony, but rather the tip, which is disposed on a robotic manipulator, makes contact with the colony or cell.

In operation, a manipulator moves to a position identified by, and relayed to, the manipulator from an image analysis component. When the manipulator reaches the identified location, a tip then contacts an adherent colony or cell and removes it from the growth substrate. The removal can comprise pneumatic-assisted removal, vacuum-assisted removal, and/or simply a scraping motion. Thus, in one embodiment, the robot arm is operatively connected to a suction source. Alternatively, the tip can perform a preliminary motion, which is calculated to remove a colony or cell from surrounding colonies or cells, before it is removed from the growth substrate.

III.C.2. Tip Design

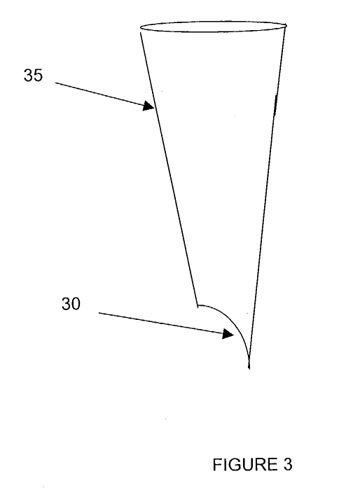

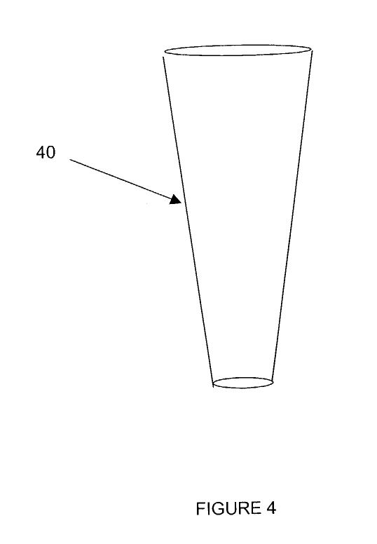

A tip designed to contact a colony or cell to be isolated comprises an aspect of the present invention. A tip can be shaped such that it forms an edge adapted to scrape a colony or cell from the surface of a growth substrate. Representative tip designs are depicted in FIGS. 3 and 4. In one embodiment, a tip is designed with regard to the mechanism by which a colony or cell is to be removed from a growth substrate. For example, if the removal is to be exclusively via aspiration techniques, a tip can be designed such that it can form an essentially airtight seal with the colony or cell, making the removal of the cell or colony more efficient. Alternatively, if the removal is to be via a physical scraping motion, a tip can be designed with a suitable scraping surface adapted to scrape a colony from the growth substrate. If a tip is to operate via a combined aspiration and scraping technique, the tip can be formed with both a scraping edge, which is formed of angles and dimensions that still permit the tip to form a seal with a cell or colony to be isolated.

FIG. 3 depicts an exemplary tip design. The tip of FIG. 3 comprises scraping surface 30 and aspiration barrel 35. Scraping surface 30 can be employed both to push a cell or colony from one position to another position and to scrape the cell or colony from the surface of a growth substrate. The tip of FIG. 3 also comprises an aspiration barrel 35. A negative pressure can be applied to aspiration barrel 35, which can temporarily associate a cell or colony with the tip for purposes of removing the structure from the growth substrate. Upon removing the cell or colony from the growth substrate, the tip can be positioned over a receiving vessel, at which time the negative pressure can be released or reversed, thereby depositing the cell or colony in or on the receiving vessel.

Alternatively, FIG. 4 depicts another tip design. The tip disclosed in FIG. 4 comprises aspiration barrel 40. When this tip is employed, a cell or colony can be isolated without the robotic manipulator performing a scraping motion. The tip of FIG. 4 can be employed to provide an initial movement of a cell or colony away from other colonies; however, the cell or colony is removed via aspiration.

The tip can comprise any suitable material, including, but not limited to glass. In one embodiment, the tip comprises a durable plastic. In another embodiment, the tip comprises reinforcing walls along the barrel to provide additional durability, which can be advantageous in the automated setting.

III.D. Receiving Vessel

An adherent colony or cell on a growth substrate can be isolated by employing the present invention. When a colony or cell is targeted for isolation by an image analysis component, a robotic manipulator moves to the location communicated to it by an image analysis component. A tip disposed on the robotic manipulator then contacts a colony or cell and isolates it (i.e., “picks” the colony or cell) from the growth substrate and transfers it to a receiving vessel.

Any container or surface can comprise a receiving vessel. In one embodiment, a receiving vessel comprises a welled plate, such as a 96 well plate or a 384 well plate. Alternatively, a colony or cell can be placed in any tube, plate, or culture dish. In one embodiment, growth media is disposed in a receiving vessel.

IV. Configuration of a Colony Identification and Isolation Apparatus

The precise configuration of a colony identification and isolation apparatus can vary with the needs of a researcher. Although in one embodiment a colony identification and isolation apparatus comprises the components described hereinabove (i.e., an image acquisition component, an image analysis component, a robotic manipulator component, and a receiving vessel), the precise configuration of these components in spatial relation to each other can vary.

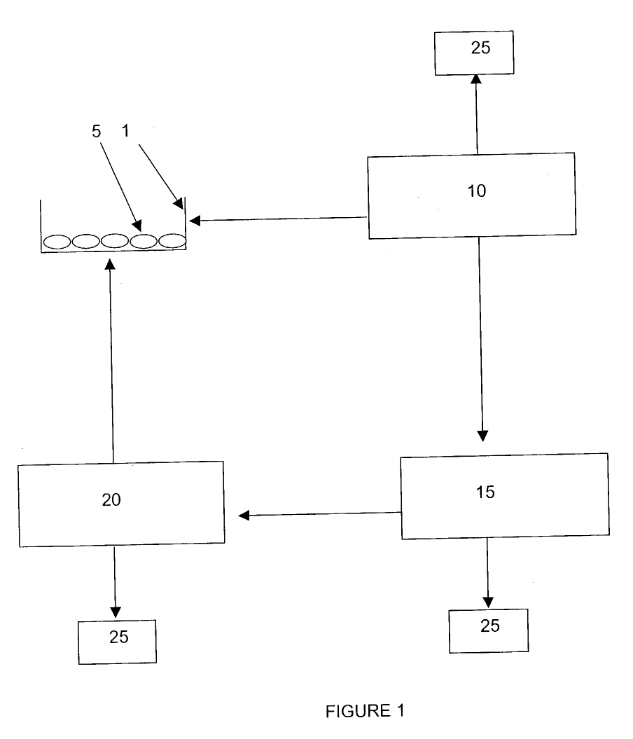

One embodiment of the present invention is presented in FIG. 1. In this figure, interactions between the various components of an identification and isolation apparatus are shown. Arrows depict the flow of data, instructions, etc., occurring during identification and isolation of a single colony or cell. Thus, the interactions depicted in FIG. 1 can be repeated until a desired number of colonies or cells are isolated, for example all suitable cells or colonies on a given growth substrate.

Referring now to the embodiment disclosed in FIG. 1, growth substrate 1 is presented. Colonies and cells 5 comprise adherent cells and are growing on substrate 1. Image acquisition component 10 communicates with growth substrate 1. Image acquisition component 10 communicates with image analysis component 15. In turn, image analysis component 15 communicates with robotic manipulator 20. Robotic manipulator 20 communicates with the colonies 1 disposed on growth substrate 5.

Output device 25 can communicate with image acquisition component 10 and image analysis component 15. In one embodiment, output device 25 is a single unit adapted to display output from image acquisition component 10, image analysis component 15, and robotic manipulator 20. In another embodiment, output device 25 can exist as a plurality of separate devices; that is, a first output device 25 can communicate with image acquisition component 10, a second output device can communicate with image analysis component 15, and a third output device can communicate with robotic manipulator 20.

V. Operation of a Cell or Colony Identification and Isolation Apparatus

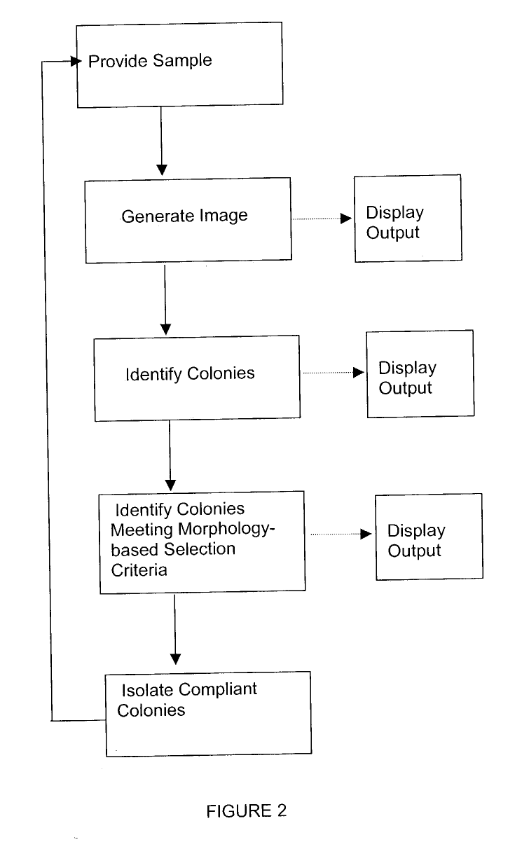

A flowchart depicting the operation of a colony identification and isolation is presented in FIG. 2. In FIG. 2, dashed lines between operations represent optional steps. In operation, a colony identification and isolation apparatus functions generally to identify and isolate one or more colonies or cells that meet a set of operator specified identification criteria. The apparatus is adapted to operate in an automated and unattended mode.

In one embodiment, however, the apparatus can operate in a semi-automatic mode, which involves both automated and manual operation. In a semi-automatic embodiment, for example, the selection of colonies can proceed by visual identification of a colony, while the process of isolating a selected colony can be performed automatically.

In yet another embodiment, the apparatus can operate in a fully manual mode, in which an operator performs all steps of the identification and isolation process. In this embodiment, for example, the processes of acquiring an image, analyzing the image, and operating a robotic manipulator can be performed manually.

In one embodiment, the mode of operation of the present invention is a fully automatic mode. In an automatic mode, an image recording device acquires an image of a growth substrate upon which a colony or individual adherent cells is disposed. The image can comprise a section of the growth substrate or the entire growth substrate. In one embodiment, the image is acquired in digital form. However, if the image is acquired in an analog form, it can be converted to a digital form following acquisition if desired.

Optionally, an output device comprises an element of the apparatus and communicates with the image acquisition component. An output device can comprise a monitor, a printer, a plotter, or any other device adapted to present an image corresponding to the image acquired by an image acquisition component. When an output device is present, the output device receives and displays the image acquired by the image acquisition component. In another aspect of the present invention, a researcher can interact with an image displayed by an output device. For example, when an output device comprises a monitor, a researcher can interact with the image by employing a light pen or by moving a cursor.

The generated image is then transmitted to an image analysis component. The image analysis component of the apparatus receives the image transmitted by the image acquisition component. The image analysis component then analyzes the image initially to identify individual colonies of adherent cells or individual adherent cells. In one embodiment, this identification process is based on an edge-detection algorithm.

An image analysis component also analyzes an image to identify a colony or cell that meets a set of operator-defined morphology-based criteria. These criteria can comprise a set of variables including, but not limited to diameter, thickness, roundness or edge regularity, degree of differentiation, regularity of surface, monoclonality, and combinations thereof. The image analysis component then determines the location of those colonies or cells that meet the selection criteria. In one embodiment, the location of a colony is described by Cartesian coordinates; however, other methods of describing the position of a colony can be employed.

When a suitable colony is identified, the coordinates of the colony on a growth substrate are transmitted to a robot manipulator. The robot manipulator then moves to the location of the colony to be isolated and removes the colony from the growth substrate. Optionally, a protease can be applied to the colony to be isolated via the robot manipulator component to facilitate isolation.

In one embodiment, the apparatus resets itself and is ready to identify and isolate another colony following the deposition of a cell or colony in a receiving vessel. Alternatively, the identification of each colony that meets the selection criteria can be completed and transmitted sequentially or in toto before the robotic manipulator begins to isolate the colonies. In one embodiment, the manipulator comprises a data storage device that is adapted to store location data for cells or colonies to be isolated when location data is transmitted to a robotic manipulator in large volumes.

Additionally, an apparatus and method of the present invention can further comprise a growth substrate transfer device or the use thereof, the growth substrate device adapted to orient a growth substrate proximate to the image acquisition component and to subsequently remove the growth substrate from the vicinity of the image acquisition component. Alternatively, a plurality of growth substrates is sequentially oriented proximate to the image acquisition component and sequentially removed from the vicinity of the image acquisition component.

In one embodiment, the apparatus is disposed in a sterile environment or, more generally, in an environment suited to tissue culture work when the apparatus is in operation. As discussed hereinbelow, an application of the present invention is in the area of selection and isolation of adherent cells, such as ES cells. Thus, in one embodiment, the apparatus is situated in conditions conducive to handling tissue cultures when the present invention is employed in the study of tissue cultures. In another embodiment, the various components of the apparatus are cleaned and sterilized (for example, by wiping the apparatus with ethanol) prior to and following each application.

VI. Applications of the Present Invention

The present invention can fill a variety of different roles and can be employed in a range of applications and situations. One application of the present invention is the identification and isolation of an adherent cell or a colony of adherent cells that meets a set of operator-determined selection criteria. In one embodiment, the selection criteria are based on desired morphological characteristics. This application can be immediately applied in the field of stem cell study. By employing the present invention, it is possible to screen large numbers of stem cells and other adherent cells for mutations and identifiable phenotypes.

VI.A. Isolation of an Adherent Cell Colony

Presently, researchers are involved in a functional genetic analysis of stem cells and other adherent cells as well. A component of almost all functional genetic analyses is a mutational analysis. In a mutational analysis, many mutations are introduced into the genetic material of a subject organism. The resultant cells are then analyzed to understand the effect of each mutation.

A difficulty associated with such a mutational analysis is the need to select those cells that have been mutated. Presently, a human researcher must perform this selection process. Following a mutagenesis treatment, the researcher examines the colonies of adherent cells growing on a growth substrate. This examination must be performed by viewing the cells through a microscope. The researcher then identifies colonies expressing a desired phenotype. The researcher then employs a manipulator, typically a pipettor, to isolate colonies meeting the selection criteria. Generally, this requires aspirating or scraping a desired colony from the growth surface and transferring the colony to a receiving vessel, such as a 96 well plate or a 384 well plate.

The present invention obviates the need for a researcher to perform the time consuming and tedious task of selecting cells meeting selection criteria. The present invention automates this process and frees researchers from having to perform the selection process. Thus, the present invention can be employed in a stem cell research program, particularly a functional genetic analysis.

VI.B. Computer Program Product

A computer program product comprising computer executable instructions embodied in a computer-readable medium for performing steps for automatically isolating a colony of adherent cells from a growth substrate based on a set of selection criteria is also provided in accordance with the present invention. In one embodiment, the steps comprise: (a) automatically generating an image of at least a portion of a sample comprising one or more colonies of adherent cells disposed on a growth substrate; (b) automatically analyzing the image by employing a selection algorithm to identify a colony to be isolated; and (c) automatically transferring the colony to be isolated from the growth substrate to a receiving vessel, whereby a colony of adherent cells from a growth substrate is isolated.

In one embodiment, the image is a digitized image. In one embodiment, the algorithm is a morphology-based selection algorithm. In one embodiment, the morphology-based selection algorithm is based on an evaluation of at least one property selected from the group consisting of diameter, thickness, roundness or edge regularity, degree of differentiation, regularity of surface, monoclonality, and combinations thereof.

The transferring can optionally employ a tip having a scraping edge. Alternatively, the transferring employs a suction source and a tip adapted to aspirate a colony from the surface of a growth substrate. In yet another alternative embodiment, the transferring employs a suction source and a tip having a scraping edge and adapted to aspirate a colony from the surface of a growth substrate.

A computer program product comprising computer executable instructions embodied in a computer-readable medium for performing steps for automatically identifying a colony of adherent cells from a growth substrate based on a set of selection criteria is also disclosed. In one embodiment, the steps comprise: (a) automatically generating a digitized image of at least a portion of the sample; and (b) automatically analyzing the digitized image by employing a morphology-based selection algorithm to identify a colony of adherent cells having a desired morphology. In one embodiment, the morphology-based selection algorithm is based on an evaluation of at least one property selected from the group consisting of diameter, thickness, roundness or edge regularity, degree of differentiation, regularity of surface, monoclonality, and combinations thereof.

### EXAMPLES

The following Examples have been included to illustrate representative modes of the invention. Certain aspects of the following Examples are described in terms of techniques and procedures found or provided by the present inventors to work well in the practice of the invention. These Examples are exemplified through the use of standard laboratory practices of the inventors. In light of the present disclosure and the general level of skill in the art, those of skill will appreciate that the following Examples are intended to be exemplary only and that numerous changes, modifications, and alterations can be employed without departing from the spirit and scope of the invention.

### Example 1

### Evaluation of Imaging Techniques

This Example evaluates image-processing techniques for the ability to identify acceptable cell colonies accurately and robustly. First, fifty images of ES cell colonies were acquired with a LEICA™ DM IL compound microscope (Leica Microsystems AG, Wetzlar, Germany) at 40× magnification. Expert cell pickers then rated the colonies on an arbitrary scale of 1-10, with a score less than 8 being unacceptable. The major features of a desirable cell colony include diameter, thickness, roundness or edge regularity, degree of differentiation, regularity of surface, and monoclonality.

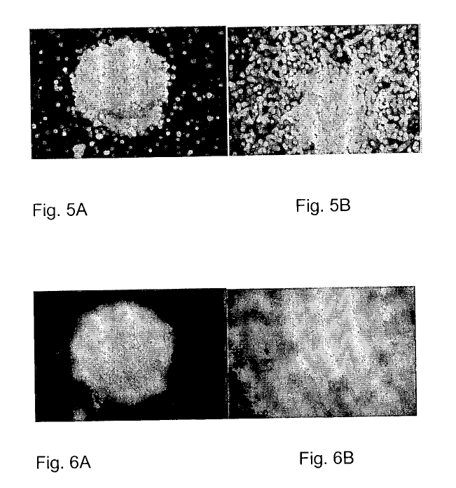

FIGS. 5A and 5B show examples of the original images of a typical desirable and undesirable cell colony, respectively. These are highly magnified 40× digitized microscopic images in 640×480 pixel matrices. In this Example, automatic image processing methods that allow for the proper identification and distinguishing of desirable from undesirable cell colonies were investigated. The image-processing algorithm was developed in the IDL image-processing environment (Research Systems, Inc., Boulder, Colo., United States of America).

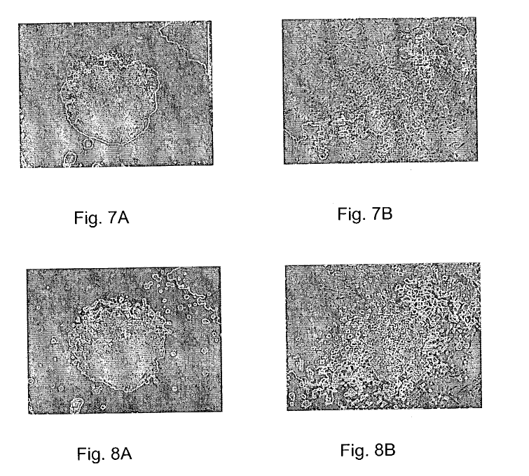

As a first step, the Sobel edge enhancement operator (see Levine 1985) was applied to the smoothed sample images shown in FIGS. 5A and 5B. FIGS. 6A and 6B show the smoothed version of the images shown in FIGS. 5A and 5B. FIGS. 7A and 7B show the edges of the colonies after the application of the Sobel edge enhancement operator. The main edge contours obtained from the Sobel operator do not match the borders of the colonies very well, even for the desirable colony. The edge contours obtained from the Sobel operator are dependent on the amount of smoothing applied to the original image. For example, FIGS. 8A and 8B show edge contours obtained if less smoothing was used. This demonstrates that the main edge contours obtained from the Sobel operator do not show significant improvement with changes in smoothing. Also, additional phantom edge contours, which are unrelated to the borders of the cell colonies, are generated.

As a second step, various improved methods were investigated to define the borders of the cell colonies. One approach was to first preprocess the original cell colony images with a morphological gradient operator that subtracts an eroded version of the original image from a dilated version of the original image. The practical result of a morphological gradient operation was that boundary features were highlighted. Edge contours were then obtained by applying the Sobel operator to a smoothed version of the preprocessed images. The method is similar to the traditional unsharp masking method except that there are no negative side lobes in the processed image and as a result, the generated edge contours were slightly larger than the object border.

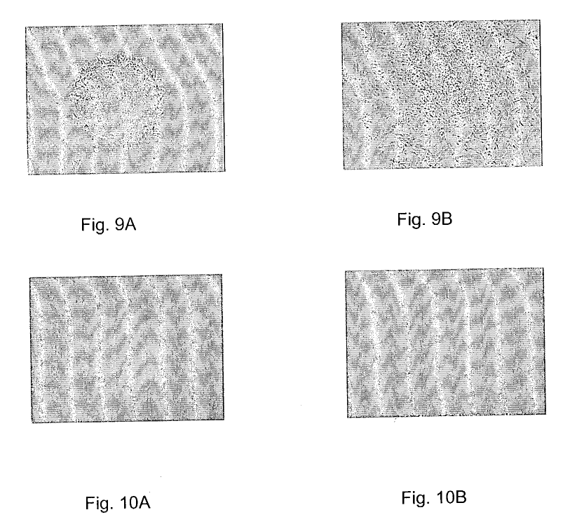

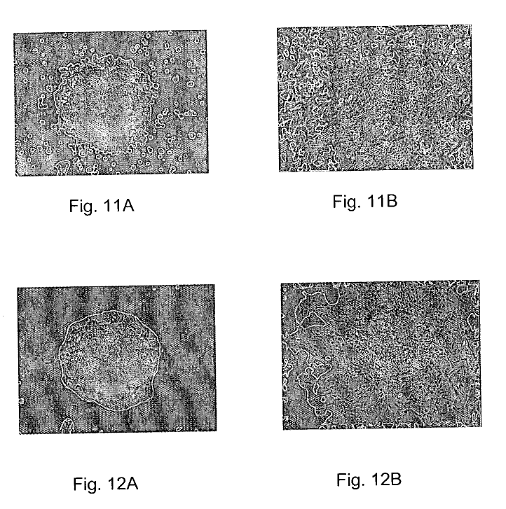

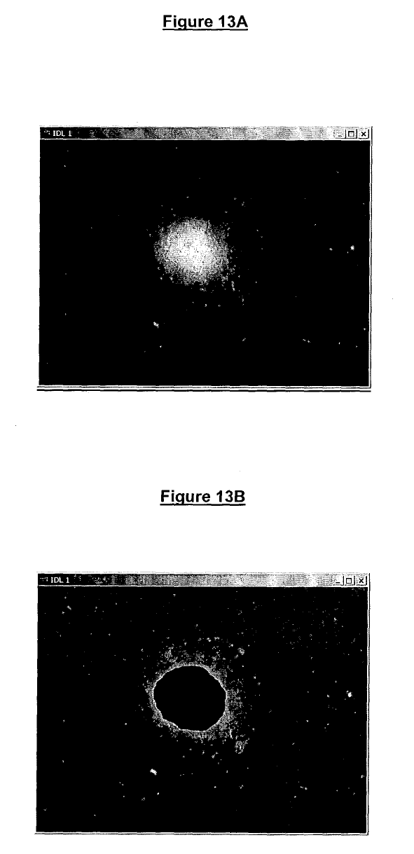

In FIGS. 9A and 9B, the preprocessed images obtained by applying the morphological gradient operator to the original cell colony images are. shown. FIGS. 10A and 10B show a smoothed version of the preprocessed images shown in FIGS. 9A and 9B. FIGS. 11 and 12 show the edge contours obtained by applying a Sobel operator to two smoothed versions of the preprocessed (a) desirable and (b) undesirable cell colony images shown in FIGS. 9A and 9B, respectively. In particular, FIG. 12 shows results from the smoothed preprocessed images shown in FIGS. 10A and 10B. The edge contour of the desirable cell colony is well defined.

From the edge contour of the desirable colony, the centroid was determined and the radius was sampled at different angles. The average radius and total area were ˜156 pixels and ˜76,881 pixels, respectively. The small standard deviation in the distribution of the radii indicates that this colony is reasonably round.

### Example 2

### Evaluation of Harvesting Approaches

The present invention also provides a mechanical system that can loosen adherent cells and that is adapted for robotic automation so that the benefits of automated, high-throughput cell picking are applied to adherent cells. Currently, two methods are used by the present co-inventors to manually pick adherent stem cells. In the first, a culture plate is placed on an inverted microscope stage and under direct vision, a pipette placed at a 15 to 25 degree angle to the culture plate is used to scrape the colony off the growth surface with a side-to-side motion. When the colony is loose, it is aspirated with the pipette. Due to the angle of the pipette and the side-to-side motion, this method does not lend itself to easy automation with a laboratory robot.

The second method comprises aspirating the colony under vacuum with a drawn glass capillary pipette. The capillary pipette is attached to plastic tubing, an in-line filter, and a mouthpiece. The operator places the pipette on the colony and aspirates the colony off the growth surface. Since the pipette diameter is smaller than the colony diameter, the pipette must be moved incrementally to aspirate the entire colony. Since the pipette can be perpendicular to the culture plate, this method is amenable to automation with a laboratory robot.

This Example measures the amount of vacuum necessary to lift the colony off the growth surface with a capillary pipette. The basic experimental set-up included a capillary pipette attached by a vacuum line to an adjustable vacuum pump. A vacuum gauge was teed into the line. Two diameters of pipettes were tested, 0.2 mm and 0.4 mm.

When the 0.2 mm capillary pipette was placed directly on top of the colony, it took 25-40 mmHg of vacuum with an inline 0.2 μM filter to lift up the portion of the colony contacting the capillary tip. Without the inline filter, the vacuum needed was only 15-25 mmHg. If some side-to-side scraping motion was applied to pre-lift the colony, less than 5 mmHg was needed to aspirate the cells. When this experiment was repeated with a 0.4 mm diameter pipette, a good seal could not be maintained between the edge of the pipette and the colony. Consequently, a large amount of medium was aspirated instead of the colony. The results of this experiment indicate that cells can be picked with low vacuum and standard capillary pipettes.

### Example 3

### Liquid Handling Robot

The backbone of an embodiment of a system of the present invention is a ROSYS™ 3000i liquid handling robot (Colibiri Robotics, New Castle, Del., United States of America). This robot includes an x-y-z gantry positioned over a 28″ by 36″ deck. The robot is equipped with four independent pipeting assemblies and a four-channel peristaltic pump for bulk fluid delivery. Additionally, a gripper hand that can lift and move up to five pounds of weight is mounted on the gantry. The gripper hand can move culture plates, microtiter plates, and reagent containers around the deck. It is also possible to move objects like cameras with the gripper hand. All motion is stepper motor-controlled with encoder feedback.

Pipeting assemblies are mounted on a rack and pinion, which controls their movement in the z-axis (vertical direction). The pipeting assemblies comprise a hollow steel mandrel attached to the rack and pinion. The hollow mandrel core is connected to a stepper motor-driven syringe pump by plastic tubing. To aspirate a solution, the pipette tip is dipped into the solution and the syringe barrel is withdrawn under stepper motor control. Both the speed and volume of aspiration are under software control. Dispensing occurs in just the opposite fashion. Conductive pipette tips allow fluid level sensing by on-board circuitry.

To mount a disposable pipette tip, the pipette mandrel is positioned over the tip rack. The mandrel is lowered into the tip hub and mounted by friction much in the way that a pipette tip is mounted on a standard laboratory pipette. For tip disposal, the pipette assembly moves into the tip ejection station. The assembly then moves horizontally into a slot that is slightly wider than the mandrel diameter, but smaller than the hub diameter. As the assembly moves upward, the pipette tip is forced off the mandrel by the edge of the slot. The disposed tip then falls down a slide into a collection container. Specialized pipette tips of the present invention conform to this paradigm.

The robot is controlled by WINRUFAS™ graphical user interface (GUI) software (Colibiri Robotics, New Castle, Del., United States of America) that runs under the WINDOWS® 2000 operating system (Microsoft, Inc., Redmond, Wash., United States of America). The program references all motions and locations to the origin. The location and geometry of all deck-mounted components is first defined in software. Once the physical layout is defined, macros to implement the various laboratory processes are written from a library of built-in subroutines. The software also has a development environment that allows specialized routines to be written as necessary. Communication with other instruments and programs is provided through support of most standard communication protocols and interfaces.

In addition to the ROSYS™ 3000i, ROSYS™ Alpha and a ROSYS™ 3300i robot are also employed (each also available from Colibiri Robotics, New Castle, Del., United States of America). These robots are very similar to the 3000i. The Alpha has a smaller deck (28″ by 28″) and does not have a gripper hand. The 3300i has a larger deck (28″ by 48″) and an integral microplate reader. All three robots operate under the WINRUFAS™ software platform.

Another robot that can be used in the present invention is the CT₂ robot from Xpo, inc. (Apex, N.C., United States of America). The Xpo CT₂ robot is a flexible, upgradeable, advanced technology platform for the adherent cell picking system. Standard configuration on this robot includes machine vision, 3 camera systems/microscopes systems, and 2 picking heads. Objects can be viewed either from above or below. Placement accuracy is 15 microns, which can be extended to the 1-10 micron range at additional cost, making single cell placement eventually feasible. The picking system is driven by linear induction motors that minimize wear and maintain accuracy with minimal maintenance. Other available options include bar coding, nanoliter dispensing, conveyor belts, and automatic tip change racks.

The robot is also designed to either stand alone or to be integrated into a production line. This robot can be linked to other machines to form integrated processes. The robot is highly upgradeable.

### Example 4

### Image-Processing Algorithm for Machine Vision

An image-processing algorithm that analyzes the cell colonies and identifies acceptable cell colonies accurately and robustly is provided. The image-processing algorithm employs the IDL image-processing environment (Research Systems, Inc., Boulder, Colo., United States of America). Currently, expert cell pickers rate the colonies on an arbitrary scale of 1-10, with a score less than 8 being unacceptable. The major features rated include diameter, thickness, roundness or edge regularity, degree of differentiation, regularity of surface, and monoclonality. The image-processing algorithm automatically identifies the same features and quantifies these features. Working with the expert cell pickers, a rating scheme for each feature is provided based on the quantitative value of the feature as determined by the image-processing algorithm. The rating scores from all the individual features are used to discriminate acceptable and unacceptable cell colonies.

### Example 5

### Identification and Quantification of Image Features of Cell Colonies

Two hundred (200) cell colonies images displaying a wide range of characteristics and features are acquired with a LEICA™ DM 1 L compound microscope at 40× magnification, and are processed by the imaging-processing algorithm. Expert cell pickers rate the individual image features, including diameter, thickness, roundness or edge regularity, degree of differentiation, regularity of surface, and monoclonality, using a 1-10 scale The image-processing algorithm is evaluated by comparing the ratings determined from the software with those independently obtained from the expert cell pickers. A separate set of similarly diverse 200 cell colonies is used in this evaluation.

Image-Processing Algorithm. Raters were asked them to assign a 0-10 value to each cell colony. However, each rater operated with the knowledge that any colony rated below 8 would be rejected. Using darkfield images, the same rejection criteria employed by human raters were used instead of attempting to duplicate their entire rating scheme. The following five criteria were identified as having the strongest impact on colony rejection. If a colony is not acceptable in any of the criteria listed, then it is rejected regardless of acceptability in other criteria.

1) Colony diameter

2) Colony roundness

3) Colony differentiation

4) Colony thickness

5) Monoclonality

These criteria have been refined based on extensive interviews with the two expert raters. During the interviews, the raters were shown randomly chosen images of colonies. For each image, each rater was asked to describe the major features that would suggest the rejection or acceptance of the colony. The images were presented in random order and the interviews were conducted one-on-one. The raters were asked to state each rejection criteria in terms of the geometric properties or intensity properties of the colony. Careful review and discussions with the raters lead to specification of the five criteria listed.

The image-processing algorithm operates by applying a sequence of conditional statistical classifiers—that is, each criterion is applied in sequence. Specifically, one classifier will be developed to reject colonies based on their diameter. Any colony that passes that test will then be evaluated for roundness. If a colony passes that test, it will be tested for its degree of differentiation. The remaining colonies will then be evaluated for thickness, and finally, monoclonality. The order of tests was chosen to maximize the amount of non-redundant information considered by each subsequent test.

Colony Diameter: preliminary studies demonstrated a method of optimizing colony edge contour definition. Once an edge contour is identified, a centroid is calculated and the diameter of the colony is determined in different radial directions. The measured diameters will be used to calculate the average diameter and its normalized standard deviation (NSD, standard deviation divided by the mean) of the individual colony. Average diameter must be between 0.7 and 1.2 mm. Preliminary steps necessary to define the boundary are (A) noise reduction in the image using a scale proportional to the expected size of the colony, (B) estimation of the colony boundary by thresholding.

A) Noise Reduction. To reduce the noise in the image, the images are blurred based on the expected size of the features in the image. The important features in the boundary of a cell colony are multi-cell indentation or protrusions. Review of rejected colonies suggests a 5 cell indentation or protrusion to be significant. Given the expected cell size of 50 microns (actually a range between 30-100 microns), this leads to the selection of a Gaussian blurring kernel with a standard deviation of 2.5*50 microns. This low-pass filtering method allows subsequent measures to automatically focus on important features and be less influenced by small-scale noise.

B) Boundary Estimation. To estimate the boundary of the colony, simple thresholding of the reduced-noise image can be employed. The tight controls placed on darkfield image acquisition enable a single threshold to be effective for every image. The threshold is about 0.25 when the image intensities are scaled from 0 to 1.

Colony roundness. Roundness is a fundamental property of acceptable colonies. Colonies that are not monoclonal will not be round. A quantitative estimate of colony roundness will be made from the NSD.

Colony differentiation. The degree of colony differentiation is one of the most important features of colony selection. Once cells become differentiated, they loose the ability to form other kinds of tissues: i.e. they are no longer stem cells. As colonies begin to differentiate and become less desirable, cells such as fibroblasts and endodermal cells begin to form. These cells have a thinner microscopic appearance than their stem cell neighbors.

To determine the degree of differentiation, the colony area is divided into two parts: a thick central core consisting nearly entirely of stem cells, and a thin, mono-cellular outer ring composed mainly of differentiated cells. After a colony boundary is set as previously described, another threshold is set for the outer boundary of the central core of stem cells. The percentage of stem cells is determined by calculating the ratio of the area of the central core to the overall colony area.

Colony thickness. Colony thickness is indicative of colony cell mass. In darkfield imaging, grey-scale intensity increases with thickness. The following steps are used to measure colony thickness: (A) measure the maximum thickness of the colony, and (B) calculate the area of the colony at its half-maximum thickness.

A) Maximum Thickness. The thickness of the colony is assumed to have a linear relationship with image intensity.

B) Half-Maximum Area. Knowing the maximum thickness (i.e., the brightest intensity) in the colony, the area of the colony brighter than half of that intensity is measured. The half-maximum threshold for area is chosen so that the area estimates will not be sensitive to fluctuations in the peaked-ness of a colony.

Monoclonality. Monoclonality is another fundamental biologic property of the colonies. A monoclonal colony is a colony in which all cells are derived from a single progenitor cell. Occasionally, two individual progenitor cells in close proximity form colonies that grow together and fuse into a larger colony. The cells of this merged colony are descendants of two different progenitors. Therefore, they are not monoclonal.

From the experience of our expert raters, non-monoclonality is the least frequently encountered rejection criteria. For this reason, this criterion is placed last in the selection sequence. Since non-monoclonal colonies start out as at least two separate round colonies, typically they have an oval shape after fusion. Most of them are eliminated in the second step when roundness is evaluated. For those that are not eliminated in step 2, the following algorithm can be employed: the major axis of the colony is defined as the maximum diameter among the radial diameters computed in step 1. The intensity profile along the major axis is computed. Colonies that are not monoclonal have more than one peak in the intensity profile and are rejected.

Evaluation of the image processing algorithms. To evaluate the effectiveness of our image processing algorithms and their classifiers, ROC analysis is performed to measure its sensitivity and specificity. 750 testing images with “truth” are collected. The 2 raters review each of these images in the same manner as the training images. The system's true-positive and false-positive rates are measured and F-ROC measures (Metz 1986) are used to determine the best balance between sensitivity and specificity based on future estimates of the cost of making each type of mistake.

### Example 6

### Darkfield Imaging of ES Cell Colonies

Fifteen darkfield images were acquired at approximately 40× magnification. Representative features of a desirable cell colony include diameter, thickness, roundness or edge regularity, degree of differentiation, regularity of surface, monoclonality, and combinations thereof. A colony, although small in sizes with a reasonably good center core with some fibroblasts around its periphery was selected for processing this set of darkfield images (see FIG. 13A). This image was preprocessed with a morphological gradient operator. A histogram was obtained for the smoothed image and a threshold set for the central core of the colony. Edge contours were then obtained by applying the Sobel operator to a smoothed version of the preprocessed images. This worked well for the central core.

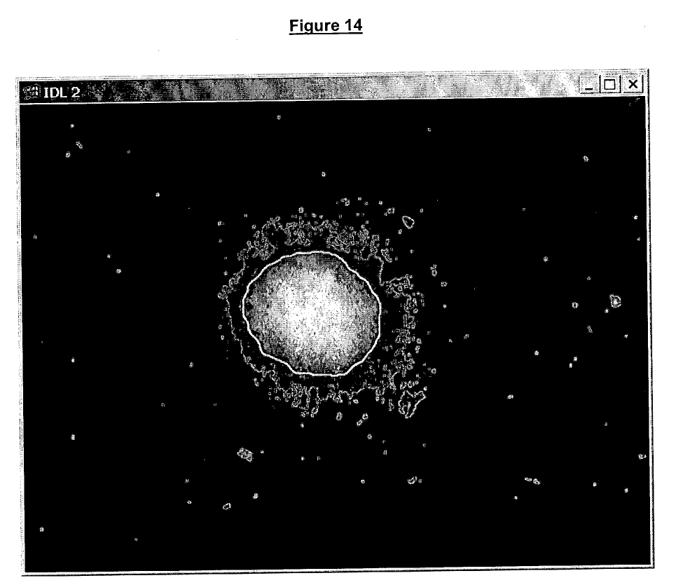

After the boundary of the central core was defined, the central core was subtracted out (see FIG. 13B), a gaussian blurring kernel is applied to the resulting image, and another histogram of the remaining peripheral cells was obtained. The unsharp masking technique was then used to establish the peripheral cell boundary. Another threshold was set for the peripheral edge of the colony. Peripheral edge contours were then obtained by applying the Sobel operator. The final result is shown in FIG. 14.

This algorithm, including the thresholds obtained from this original image, was then applied to the other 14 members of this image set with good results, even in cases of highly irregular geometry.

### Example 7

### Image Capture System

The images that are used by the image-processing algorithm are acquired at high resolution. There is a trade-off between resolution and the size of the field of view. The required resolution is determined by software simulation. Images are collapsed to a lower resolution in software and test the ability of the image-processing algorithm to successfully discriminate colonies. Once an estimate of the required resolution is completed, appropriate cameras and lenses are selected.

Camera requirements. The Lawrence Berkeley National Laboratory's Colony Picking Machine employs a PULNIX™ 640×480 pixel, model TM745E monochrome CCD camera (Pulnix America, Inc., Sunnyvale, Calif., United States of America). The MANTIS™ bacterial cell colony picker used at the International Genome Resource Center of the Max Planck Institute (Berlin, Germany) is equipped with a PULNIX™ 600 by 400 pixel, model TM6 monochrome CCD camera (Pulnix America, Inc., Sunnyvale, Calif., United States of America; Hallett & Hallett 2000). This machine requires 100 steps to image a 22 cm by 22 cm culture plate. This equipment can provide the required resolution.

Camera placement. Once resolution is determined, the number and placement of cameras is decided. Optional positions for the camera(s) include mounted to the gantry or mounted under the robot deck. Also, the gripper hand can lift up to five pounds in weight, which can include one or more cameras.

An array of cameras can optionally be employed. The more cameras in an array, the fewer steps needed to image a culture plate. Alternatively, two cameras are employed, one of low resolution and another of high resolution in a two-step imaging process. The low resolution camera can be picked up by the gripper hand and used to image a large field and spot potential candidate colonies. The gripper hand can then pick up the high resolution camera to image the potential candidates individually and then implement the high resolution features of the image-processing algorithm.

### Example 8

### Robotic System to Pick Adherent Cells

Pipette Tip. As disclosed in Example 2 above, a 0.2 mm capillary pipette can successfully aspirate adherent cells from the culture plate surface. A pipette tip that is adapted for robotic automation is fabricated. To be adapted for robotic automation, a pipette tip must have sufficient strength to withstand the pressure exerted upon it as the mandrel is lowered into the pipette tip hub as it lies in the pipette rack. A suitable capillary pipette is cast in plastic. While the lumen of the pipette is optimally 0.2 mm diameter, the actual pipette diameter can be larger, thereby adding strength. As an alternative, hypodermic needles specially modified by removal of the bevel can also be employed. An American Wire Gauge #32 needle has a 0.2 mm outside diameter. A hypodermic needle hub is very similar to the hub of a pipette tip. As a final alternative, a pipette tip with an integral scraper on the end is provided. Any of the designs can custom fabricated, for example by Colibri Robotics, New Castle, Del., United States of America.

Vacuum System. As disclosed in Example 2 above, between 5 and 40 mmHg of vacuum are sufficient for detaching cells from the growth surface. There are at least two ways of generating the required vacuum. In one embodiment, when the barrel of the stepper motor-driven syringe pump is withdrawn, a vacuum is generated. This vacuum is measured during multiple rates of withdrawal with an in-line vacuum gauge. In another embodiment, if the vacuum thus generated is insufficient, a regulated vacuum source is connected to the pipette assembly and the vacuum is controlled with a computer-controlled valve. This second embodiment includes additional programming for interfacing and control.

Motion. From manual picking, it is known that colonies are more easily picked when the edge is first loosened. As disclosed in Example 2 above, a small amount of vacuum is needed if some side-to-side scraping motion is employed during picking. The rate, speed, and pattern of picking are varied in order to optimize the picking process.

Development Platform. The robots can operate in a manual mode, which allows them to function as a micropositioner. After manual positioning, macros are activated to perform small procedures, i.e. programmed movements. An inverted microscope is placed on the deck of one of the ROSYS™ robots. Pipette tips are lowered under manual robot control onto cell colonies in culture plates on the microscope stage. Pipeting experiments are performed under direct vision and recorded when necessary. Pipette tip design, vacuum, picking speed, and picking pattern can optionally be varied. Multiple robots operating under the same software package and of similar hardware configurations can also be employed.

### Example 9

### System Integration

The machine vision system passes the coordinates of desirable colonies to the picking system. Since the image processing environment (which in one embodiment employs IDL™ software from Research Systems, Inc., Boulder, Colo., United States of America) and the robot control program (which in one embodiment employs WINRUFAS™ software from Colibri Robotics, New Castle, Del., United States of America) are both WINDOWS®-based programs, they are in one embodiment linked with a program in MICROSOFT® VISUAL™ C⁺⁺ language, (Microsoft Inc., Redmond, Wash., United States of America). Any additional graphical user interfaces are written in MICROSOFT® VISUAL™ Basic, (Microsoft Inc., Redmond, Wash., United States of America). A thermostated and environmentally controlled enclosure houses the system, and temperature, humidity, gas composition, and sterility are controlled. Optionally, the system is placed in an environmental containment hood, although a custom enclosure saves space.

### VIII. CONCLUSION

The present invention can be employed in a range of applications, notably as a method of high-throughout screening large numbers of mutagenized cells. The high cost of animal husbandry and the difficulties in monitoring and optimizing mutation frequency are significant limitations of the whole-animal mutagenesis approach. An alternative strategy is to generate mutations in totipotent embryonic stem cells and then derive mice from them. A high mutation rate coupled with high throughput mutation detection technology renders this approach applicable to generating mutations in any gene of interest, thereby creating an allelic series of mutations pivotal for a complete dissection of biological pathways. A cryopreserved bank of mutagenized cells can also be generated through these means.

The current rate-limiting step in this process is the handpicking of colonies into 96 well plates, 384 well plates, or other desired reservoirs. The present invention automates this step by providing a robotic system that can automatically recognize suitable ES cell colonies and isolate them into suitable receiving vessels. Thus, the present invention will not only save researchers time and money by automating a time consuming process, but will greatly speed the progress of such functional genetic analyses. The present invention can also be employed to identify and isolate any adherent cells or cell colonies, and is thus not confined to stem cell research. The present invention, therefore, is a significant advance beyond prior art cell identification and isolation methods and will be of great assistance to those employing an adherent cell model system in general, and a stem cell model system in particular.

### REFERENCES

The references listed below as well as all references cited in the specification are incorporated herein by reference to the extent that they supplement, explain, provide a background for or teach methodology, techniques and/or compositions employed herein.

AUTOGENESYS™ Automated Colony and Plaque Picking, AutoGen, Inc., Framingham, Mass., United States of America (http://www.autogen.com/autogenesys.htm)

BIOPICK™ automated colony picking system, BioRobotics, Inc., Woburn, Mass., United States of America, http://www.biorobotics.com/, 2001

Chen, Y., Schimenti, J., and Magnuson T., (2000) Mamm Genome 11:598-602)

Colony Picking Machine, Lawrence Berkeley National Laboratory Human Genome Center, University of California at Berkeley, Berkeley, Calif., United States of America

Doetschman et al., (1985) J. Embryol. Exp. Morph. 87: 27-45

Driever, W., et al., (1996) Development 123:37-46

Evans et al., (1981) Nature 292: 154-159

Haffter, P., et al., (1996) Development 123:1-36

Hallett, J. and Hallett, A., (2000) Vision Systems Design 5:33-36

Hayashi, K., (1999) Genet Anal 14:193-6

Justice, M. J. and Bode, V. C., (1986) Genet Res 47:187-92

Kasarskis, A., Manova, K., and Anderson, K. V., (1998) Proc Natl Acad Sci USA 95:7485-90

Levine, M. D., Vision in Man and Machine, McGraw-Hill, 1985

Martin, (1981) Proc. Natl. Acad. Sci. U.S.A. 78: 7634-7638

Matsui et al., (1992) Cell 70: 841-847

Metz CE, (1986) Invest. Radiol. 21: 720-33.

Nolan, P., Kaphhamer, D., and Bucan, M., (1997) Methods (1997) 13:379-95

QPIX2™ Colony Picker, Genetix, Ltd., Queensway, New Milton, Hampshire, United Kingdom

Richard et al., (1994) Cytogenet. Cell Genet. 65: 169-171

Rinchik, E. M. and Carpenter, D. A., (1999) Genetics 152:373-83

Rinchik, E. M., et al., (1994) Genetics 137:845-54

Shedlovsky, A., King, T. R., and Dove, W. F., (1988) Proc Natl Acad Sci USA (1988) 85:180-4

U.S. Pat. No. 4,878,114

U.S. Pat. No. 4,969,198

U.S. Pat. No. 5,099,521

U.S. Pat. No. 5,311,600

U.S. Pat. No. 5,830,141

U.S. Pat. No. 5,843,644

Vitaterna, M. H., et al., (1994) Science 264:719-25

Williams et al., (1988) Nature 336: 684-687

It will be understood that various details of the invention may be changed without departing from the scope of the invention. Furthermore, the foregoing description is for the purpose of illustration only, and not for the purpose of limitation-the invention being defined by the claims.

What is claimed is:

1. An apparatus for the automated isolation of a colony of adherent cells from a growth substrate based on a set of selection criteria, the apparatus comprising:
(a) an image acquisition component comprising an image recording device;
(b) an image analysis component comprising a selection algorithm; and
(c) a robotic manipulator component adapted to remove an adherent cell from a growth substrate,
wherein the image acquisition component, the image analysis component and the robotic manipulator component are adapted to send, receive, or both send and receive signals from each other.

2. The apparatus of claim 1, wherein the image acquisition component comprises an analog-to-digital converter.

3. The apparatus of claim 1, wherein the image acquisition component comprises a frame grabber.

4. The apparatus of claim 1, wherein the image acquisition component further comprises a scanning component adapted to acquire an image by rastering.

5. The apparatus of claim 1, wherein the image recording device is a digital still camera.

6. The apparatus of claim 1, wherein the image recording device is a video camera.

7. The apparatus of claim 1, wherein the image acquisition component further comprises a source of illumination.

8. The apparatus of claim 7, wherein the image acquisition component further comprises a component adapted to detect fluorescence.

9. The apparatus of claim 8, wherein the fluorescence is the natural fluorescence of a colony.

10. The apparatus of claim 8, wherein the fluorescence is emitted from an introduced fluorescent label.

11. The apparatus of claim 1, wherein the image acquisition component further comprises a magnifying device.

12. The apparatus of claim 11, wherein the magnifying device is a light microscope.

13. The apparatus of claim 12, wherein the light microscope is selected from the group consisting of an inverted light microscope, a darkfield microscope, a confocal microscope, and a phase microscope.

14. The apparatus of claim 1, wherein the image analysis component comprises a microchip embodying the selection algorithm.

15. The apparatus of claim 1, wherein the image analysis component comprises a computer running the selection algorithm.

16. The apparatus of claim 1, wherein the selection algorithm is a morphology-based selection algorithm.

17. The apparatus of claim 16, wherein the morphology-based selection algorithm is based on an evaluation of at least one property selected from the group consisting of diameter, thickness, roundness or edge regularity, degree of differentiation, regularity of surface, monoclonality, and combinations thereof.

18. The apparatus of claim 1, wherein the robotic manipulator component comprises a tip having a scraping edge.

19. The apparatus of claim 1, wherein the robotic manipulator component comprises a tip adapted to aspirate a colony from the surface of a growth substrate.

20. The apparatus of claim 1, wherein the robotic manipulator component comprises a tip having a scraping edge and adapted to aspirate a colony from the surface of a growth substrate.

21. The apparatus of claim 18, 19, or 20, wherein the tip is removable from the robotic manipulator.

22. The apparatus of claim 21, wherein the tip is disposable.

23. The apparatus of claim 1, wherein the robotic manipulator is adapted to recognize a position represented by Cartesian coordinates.

24. The apparatus of claim 1, further comprising a vacuum source operatively connected the robotic manipulator.

25. The apparatus of claim 1, further comprising a receiving vessel.

26. The apparatus of claim 25, wherein the receiving vessel comprises a 96 well plate, a 384 well plate.

27. The apparatus of claim 1, further comprising a growth substrate transfer device adapted to orient a growth substrate proximate to the image acquisition component and to subsequently remove the growth substrate from the vicinity of the image acquisition component.

28. The apparatus of claim 27, wherein a plurality of growth substrates is sequentially oriented proximate to the image acquisition component and sequentially removed from the vicinity of the image acquisition component.

29. A method for the automated isolation of a colony of adherent cells from a growth substrate based on a set of selection criteria, the method comprising:
(a) providing a sample comprising one or more colonies of adherent cells disposed on a growth substrate;
(b) automatically generating an image of at least a portion of the sample;
(c) automatically analyzing the image by employing a selection algorithm to identify a colony to be isolated; and
(d) automatically transferring the colony of adherent cells to be isolated from the growth substrate to a receiving vessel, whereby a colony of adherent cells from a growth surface is isolated.

30. The method of claim 29, wherein the image is a digitized image.

31. The method of claim 30, wherein the digitized image is generated by a digital still camera.

32. The method of claim 31, wherein an analog-to-digital converter is employed in generating the digitized image.

33. The method of claim 30, wherein a frame grabber is employed in generating the digitized image.

34. The method of claim 30, wherein rastering is employed in generating the digitized image.

35. The method of claim 30, wherein a light microscope is employed in generating the digitized image.

36. The method of claim 35, wherein the light microscope is selected from the group consisting of an inverted light microscope, a darkfield microscope, a confocal microscope, and a phase microscope.

37. The method of claim 29, wherein the algorithm is embodied on a microchip.

38. The method of claim 29, wherein the analyzing is performed by a computer running the selection algorithm.

39. The method of claim 38, wherein the algorithm is a morphology-based selection algorithm.

40. The method of claim 39, wherein the morphology-based selection algorithm is based on an evaluation of at least one property selected from the group consisting of diameter, thickness, roundness or edge regularity, degree of differentiation, regularity of surface, monoclonality, and combinations thereof.

41. The method of claim 29, wherein the transferring employs a tip having a scraping edge.

42. The method of claim 29, wherein the transferring employs a suction source and a tip adapted to aspirate a colony from the surface of a growth substrate.

43. The method of claim 29, wherein the transferring employs a suction source and a tip having a scraping edge and adapted to aspirate a colony from the surface of a growth substrate.

44. The method of claim 41, 42, or 43, wherein the tip is disposable.

45. The method of claim 29, wherein the colony is transferred to a 96 well plate or a 384 well plate.

46. The method of claim 29, further comprising orienting the sample proximate to an image acquisition component and subsequently removing the sample from the vicinity of the image acquisition component.

47. The method of claim 46, wherein a plurality of samples are sequentially oriented proximate to an image acquisition component and sequentially removed from the vicinity of the image acquisition component.

48. The method of claim 29, further comprising applying a protease to the colony to be isolated.

49. A method of identifying a colony of adherent cells having a desired morphology, the method comprising:
(a) providing a sample comprising one or more colonies of adherent cells disposed on a growth substrate;
(b) automatically generating a digitized image of at least a portion of the sample; and
(c) automatically analyzing the digitized image by employing a morphology-based selection algorithm to identify a colony of adherent cells having a desired morphology.

50. The method of claim 49, wherein the digitized image is generated by a digital still camera.

51. The method of claim 49, wherein an analog-to-digital converter is employed in generating the digitized image.

52. The method of claim 49, wherein a frame grabber is employed in generating the digitized image.

53. The method of claim 49, wherein rastering is employed in generating the digitized image.

54. The method of claim 49, wherein a light microscope is employed in generating the digitized image.

55. The method of claim 54, wherein the light microscope is selected from the group consisting of an inverted light microscope, a darkfield microscope, a confocal microscope, and a phase microscope.

56. The method of claim 49, wherein the algorithm is embodied on a microchip.

57. The method of claim 49, wherein the analyzing is performed by a computer running the morphology-based selection algorithm.

58. The method of claim 49, wherein the morphology-based selection algorithm is based on an evaluation of at least one property selected from the group consisting of diameter, thickness, roundness or edge regularity, degree of differentiation, regularity of surface, monoclonality, and combinations thereof.

59. A computer program product comprising computer executable instructions embodied in a computer-readable medium for performing steps for automatically isolating a colony of adherent cells from a growth substrate based on a set of selection criteria, the steps comprising:
(a) automatically generating an image of at least a portion of a sample comprising one or more colonies of adherent cells disposed on a growth substrate;
(b) automatically analyzing the image by employing a selection algorithm to identify a colony to be isolated; and
(c) automatically transferring the colony to be isolated from the growth substrate to a receiving vessel, whereby a colony of adherent cells from a growth substrate is isolated.

60. The computer program product of claim 59, wherein the image is a digitized image.

61. The computer program product of claim 59, wherein the digitized image is generated by a digital still camera.

62. The computer program product of claim 59, wherein an analog-to-digital converter is employed in generating the digitized image.

63. The computer program product of claim 59, wherein a frame grabber is employed in generating the digitized image.

64. The computer program product of claim 59, wherein rastering is employed in generating the digitized image.

65. The computer program product of claim 59, wherein a light microscope is employed in generating the digitized image.

66. The computer program product of claim 59, wherein the algorithm is a morphology-based selection algorithm.

67. The computer program product of claim 66, wherein the morphology-based selection algorithm is based on an evaluation of at least one property selected from the group consisting of diameter, thickness, roundness or edge regularity, degree of differentiation, regularity of surface, monoclonality, and combinations thereof.

68. The computer program product of claim 59, wherein the transferring employs a tip having a scraping edge.

69. The computer program product of claim 59, wherein the transferring employs a suction source and a tip adapted to aspirate a colony from the surface of a growth substrate.

70. The computer program product of claim 59, wherein the transferring employs a suction source and a tip having a scraping edge and adapted to aspirate a colony from the surface of a growth substrate.

71. A computer program product comprising computer executable instructions embodied in a computer-readable medium for performing steps for automatically identifying a colony of adherent cells from a growth substrate based on a set of selection criteria, the steps comprising:
(a) automatically generating a digitized image of at least a portion of the sample; and
(b) automatically analyzing the digitized image by employing a morphology-based selection algorithm to identify a colony of adherent cells having a desired morphology.

72. The computer program product of claim 71, wherein the morphology-based selection algorithm is based on an evaluation of at least one property selected from the group consisting of diameter, thickness, roundness or edge regularity, degree of differentiation, regularity of surface, monoclonality, and combinations thereof.
